(19) United States
(12) Patent Application Publication
(10) Pub. No.: US 2023/0276818 A1
(43) Pub. Date: Sep. 7, 2023

(54) METHODS AND SYSTEMS FOR REDUCING FRYER OIL DEGRADATION

(71) Applicant: Spellbound Development Group, Inc., Irvine, CA (US)

(72) Inventors: Earl Joseph Votolato, Newport Beach, CA (US); Carlos David Reyes, Rancho Santa Margarita, CA (US); Michael Thomas Flynn, Corte Madera, CA (US)

(21) Appl. No.: 18/177,357

(22) Filed: Mar. 2, 2023

Related U.S. Application Data
(60) Provisional application No. 63/316,803, filed on Mar. 4, 2022.

(51) Int. Cl. A23D 9/04; A23D 9/007; A23L 5/20; A47J 37/12

(52) U.S. Cl. CPC A23D 9/04; A23D 9/007; A23L 5/273; A47J 37/129

(57) ABSTRACT

Disclosed are methods and systems that enable real-time, continuous reduction in the rate of degradation of oils used to fry foods. The disclosed methods and systems accomplish this by reducing the rate of accumulation of undesirable oil breakdown byproducts, keeping the levels of these undesirable compounds below those at which food quality is negatively impacted and oil degradation accelerates. The disclosed methods and systems thus enable improved frying oil lifetimes, decreased frying oil consumption, greater consistency in fried food quality, and/or improvements in worker safety relative to conventional frying methods.

### CROSS-REFERENCE TO RELATED APPLICATION

This application claims the benefit of priority of U.S. Provisional Patent Application 63/316,803, filed 4 Mar. 2022, the entirety of which is incorporated herein by reference.

### FIELD

This disclosure relates generally to the frying of foods, and particularly to methods and systems that reduce the rate of frying oil degradation.

### BACKGROUND

Fried foods are very popular around the world. In many segments of the food service industry, especially in the quick-service restaurant (QSR) segment, the cost of frying oils can be a very significant fraction of recurring operating costs. To date, the model for use of frying oils in the food service industry has generally been to take what may be termed “oil management” measures—that is, to attempt to control such parameters as temperature, entrained food crumb content, air and moisture exposure, and so on—during the useful life of the oil, and then to dispose of the oil when the oil has degraded to the point that the quality of food fried in the oil becomes unacceptable. This model results in millions of dollars annually in wasted oil and other unnecessary costs, as well as degraded and/or inconsistent food quality, which in turn can negatively affect consumer appeal, branding, etc.

Trends toward healthier frying oils, driven in part by changes in food labeling regulations that set lower limits on trans-fat content in foods, have resulted in increased use of edible vegetable oils and vegetable oil blends for frying. As compared to other edible oils, e.g., tallow, vegetable oils are less thermally stable and degrade more rapidly during normal use at frying temperatures (typically from about 330 to about 360° F.) due in large part to thermally driven oxidation, hydrolysis, and polymerization reactions. As frying oil degrades, triglyceride chains in the oil break down and undesirable byproducts of the oxidation and hydrolysis reactions, such as polar materials and compounds (measured in terms of “total polar materials” (TPM) or “total polar compounds” (TPC)), free fatty acids (FFAs), and mono- and diglycerides accumulate in the frying vessel and have a negative impact on food quality, the nutritional impact of the frying oil, and on the overall frying performance of the frying system. Particularly, as the oil degrades, its viscosity increases and its smoke point decreases, both of which are detrimental to frying performance and food quality.

Oxidation of frying oils can also produce compounds such as hydroperoxides, aldehydes, ketones, carboxylic acids, short-chain alkanes and alkenes, and other volatile and/or low-molecular weight products that are responsible for rancidity and its associated odors and flavors and can react with amines, amino acids, and proteins in fried foods, causing loss of nutrients and browning of the food. Other oxidation products, such as dimers, non-polar polymers, cyclic monomers, trans isomers, and position isomers, can also be generated by free radical and/or Diels-Alder reactions, depending on the types of fatty acids present in the oil.

FFAs are generated by hydrolysis of the ester bonds in triglyceride molecules when the heated frying oil is exposed to water in the food being fried. This reaction with water decomposes the triglycerides to form FFAs, monoglycerides, diglycerides, and glycerol molecules. These breakdown compounds have higher polarities and lower molecular weights than the original unadulterated triglycerides and can further accelerated hydrolysis reactions in the oil. These FFAs created during hydrolysis reactions are rapidly oxidized and increase the rate of thermal oxidation by solubilizing transition metals, e.g., iron and copper, in the oil. Higher FFA content in edible oils not only increases the rate of oxidation but also increases the acidity of the oil and leads to formation of volatile compounds that are responsible for off-flavors in the oil (and thus in foods fried in the oil).

Most edible vegetable frying oils, oil blends, and shortenings used in food service, restaurant, and high-volume commercial frying operations are made up of a complex mixture of saturated, monounsaturated, polyunsaturated, and trans fats. When the oil is fresh, i.e., before it has been exposed to the high temperatures of frying operations and other oil-degrading conditions (oxygen and water vapor in the atmosphere, light, metals such as copper and iron, foods with high moisture content, etc.), the levels of FFAs and TPMs/TPCs in the oil are generally quite low; unused high-quality frying oils, which are usually obtained by the refining of natural oils to remove non-triglyceride components, are typically about 90 wt % to about 95 wt % triglycerides, about 2 wt % to about 3 wt % of each of diglycerides/monoglycerides, about 0.05 wt % to about 0.5 wt % FFAs, and about 2 wt % to about 5 wt % TPMs/TPCs. As the frying oils are heated and contact air, water, and materials carried into the oil by the food being fried in each of many frying cycles, thermally driven oxidation and hydrolysis reactions, among other secondary reactions, begin to cause degradation of the oil and accumulation of undesirable byproducts, including FFAs and TPMs, in the oil, which in turn affects the quality of the food being fried. Importantly, the rate of this degradation does not remain constant over time; as triglyceride decomposition byproducts accumulate in the oil, their presence increases the overall rate of oxidation and other thermally induced oil breakdown reactions in a phenomenon known as autooxidation. By the end of the oil's usable life, its chemical composition has changed dramatically, with significantly lower amounts (typically about 50 wt % to about 60 wt %) of triglycerides and significantly higher amounts of diglycerides (typically about 15 wt % to about 20 wt %) and monoglycerides (typically about 18 wt % to about 25 wt %).

Due to the detrimental effects on food quality and human health exerted by hydrolysis byproducts such as FFAs and oxidation byproducts such as TPMs, regulatory bodies in various countries have set mandatory or recommended maxima on the TPM content (typically 24 to 27 wt %) or the content of FFAs generally and/or linoleic acid specifically (typically 0.9 to 2.5 wt %) in frying oils. Some countries may also have regulatory limits on the amount of FFAs that can be present in certain fried food products; for example, Japan limits the FFA content in shelf-stable fried noodles to no more than 1.5 wt %, and South Korea limits the FFA content in sweet-and-sour fried pork to no more than 2.5 wt %. Determining compliance with these requirements can be challenging, however; while techniques for objectively and quantitatively measuring TPM and FFA levels in frying oils “on the spot” do exist, they can be expensive, difficult to use, and/or require significant employee training. Some frying operations may therefore use simpler and easier techniques for determining oil quality, such as the use of color tests (e.g., by color comparison charts), clarity gauges, or dipsticks, but while these can be helpful measures, they yield only approximate results and so contribute to both premature disposal of usable oil and the use of oil that has degraded beyond regulatory and/or acceptable food quality limits.

With respect to TPMs particularly, there have been some efforts in the art to provide active or passive absorption or adsorption of TPMs from frying oils during their useful lifecycle. However, each of these techniques suffers from one or more major shortcomings, the most typical of which are (1) in the case of both passive and active filtration techniques, requiring one or more additional non-in situ steps in handling or processing used oils; (2) being “off-line” techniques, i.e., not being incorporated into the normal operations of food service providers; (3) utilizing disposable, single-use absorbents or adsorbents, which generate additional waste streams that often require special handling and/or added disposal costs; and/or (4) having a limited positive impact on the overall oil quality by a device or system that only addresses one or two oil-degradation factors. As a result, more advanced TPM adsorption techniques have mostly been studied academically and have had little or no commercial viability.

Given these regulatory restrictions and difficulties in determining compliance, as well as the challenges associated with providing a commercially viable solution that can address the overall oil quality and extend useful oil life by addressing FFA levels, absorbing or adsorbing TPMs, and addressing the negative operational effects of oil degradation (e.g., accelerating further degradation of the oil, increasing oil viscosity, reducing heat transfer, reducing the oil's smoke point, increasing oil absorption in the fried food, causing undesirable coloring in the oil and the food, negatively impacting food quality and consistency, etc.), the food service industry has devoted significant resources to minimizing frying oil oxidation and improving the oxidative stability of edible oils. Large frying oil producers and processors have had some success in improving vegetable oil blends and incorporating very small amounts (typically on the order of parts per million) of antioxidant additives (e.g., ascorbic acid, ascorbyl palmitate, butylated hydroxyanisole (BHA), calcium silicate, carotenoids, citric acid solutions, propyl gallate, rosemary extract, tertiary butylhydroquinone (TBHQ), etc.) that help improve the oil's stability during transport, storage, and (to a limited extent) operation at frying temperatures; however, some of these additives present risks to the health of food service workers and/or consumers (for example, ascorbyl palmitate is known to be toxic to epidermal cells and may intensify skin damage in certain conditions, and BHA is known to cause cancer in rodents and, according to the National Toxicology Program, is reasonably anticipated to be a human carcinogen). Current industry practices to attempt to mitigate the negative effects of oil degradation due to oxidation and hydrolysis include such techniques as filtration of the oil to remove food particulates (e.g., using activated carbon embedded filtration systems), use of chemically reactive additives (e.g., calcium silicate, citric acid solutions, and/or other similar antioxidants) to absorb, adsorb, agglomerate, and/or neutralize oxidation byproducts, viscosity modification techniques, and the use of reduced oil volume (ROV) fryers. These techniques generally have limited application, however, due to implementation costs, marginal improvements in oil life, and/or significant issues with process compliance, personnel safety, food safety, and operational complexity for the restaurants and processing facilities where they are implemented; by way of non-limiting example, filtration and handling of hot oil is a worker safety concern, and chemical additives can contaminate the food without proper control measures.

Despite all of these and other approaches and techniques for extending the life of frying oils, the average useful life of frying oil for many restaurant operations remains at about three days; some operations can extend this to five days and in rare cases to seven days, but even these cases require the use of multiple costly and time-consuming procedures and/or materials, sometimes with increased risk of injury to employees and operators. Thus, given the potential for very large oil cost savings, improved consistency (i.e., reliability and repeatability) and quality of fried foods, reduced dependence on complex compliance procedures, improved operator safety, and improved healthiness of the frying oil, there is a need in the art for methods and systems that can enable individual food service locations to effectively and efficiently increase the life of frying oils by multiple times, rather than the marginal improvements (generally 10% to 50%) that can be achieved using conventional techniques and materials.

### SUMMARY

In an aspect of the present disclosure, a method for reducing degradation of a frying oil comprises contacting the frying oil with a catalyst selected from the group consisting of zinc metal, chloride salts of zinc or tin, oxide salts of zinc or tin, sulfate salts of zinc or tin, and combinations thereof; and maintaining the frying oil at a temperature from about 120° C. to about 200° C. during the contacting step.

In embodiments, no exogenous reactant may be added to a vessel in which the contacting step is carried out.

In embodiments, the frying oil and the catalyst may remain in contact continuously for a period of at least about three hours, at least about six hours, at least about nine hours, at least about twelve hours, at least about eighteen hours, at least about one day, at least about two days, at least about three days, at least about four days, at least about five days, at least about six days, at least about seven days, at least about eight days, at least about nine days, at least about ten days, at least about eleven days, at least about twelve days, at least about thirteen days, at least about fourteen days, at least about fifteen days, at least about sixteen days, at least about seventeen days, at least about eighteen days, at least about nineteen days, at least about twenty days, at least about 21 days, at least about 22 days, at least about 23 days, at least about 24 days, at least about 25 days, at least about 26 days, at least about 27 days, at least about 28 days, at least about 29 days, or at least about 30 days.

In embodiments, the contacting step may be carried out for a predetermined period, and at the end of the predetermined period at least one of the following may be true: (i) the frying oil comprises no more than about 3 wt % free fatty acids; (ii) the frying oil comprises no more than about 25 wt % polar compounds; (iii) the frying oil comprises no more than about 18 wt % monoglycerides; (iv) the frying oil comprises no more than about 15 wt % diglycerides; and (v) the frying oil comprises at least about 60 wt % triglycerides. At least one of (i), (ii), (iii), (iv), and (v) may, but need not, be true at all times during the predetermined period.

In embodiments, the contacting step may prevent, or decrease the rate of, an autooxidation reaction.

In embodiments, the contacting step may be carried out in a frying vessel and food may be fried in the frying oil contained in the frying vessel during at least part of a duration of the contacting step. It may, but need not, be the case that, during at least part of the duration of the contacting step, food is not fried in the frying oil contained in the frying vessel.

In embodiments, the temperature may be from about 150° C. to about 190° C. The temperature may, but need not, be about 170° C.

In embodiments, the contacting and maintaining steps may be carried out at an ambient pressure of no more than about 1 atm. The ambient pressure may, but need not, be from about 90 kPa to about 1 atm.

In embodiments, the catalyst may be selected from the group consisting of zinc metal, zinc chloride (ZnCl₂), zinc oxide (ZnO), zinc sulfate heptahydrate (ZnSO₄·7H₂O), tin(II) chloride dihydrate (SnCl₂·2H₂O), tin(IV) chloride pentahydrate (SnCl₄·5H₂O), and combinations thereof.

In embodiments, at an outset of the contacting step, a molar ratio of glycerol to free fatty acids in the frying oil may be between about 0.5 and about 2.0. The molar ratio of glycerol to free fatty acids in the frying oil may, but need not, be about 1.0.

In embodiments, the catalyst, not including the catalyst support, may be present in an amount from about 0.05 wt % to about 1.5 wt % of a total weight of the frying oil.

In embodiments, the catalyst may be insoluble or poorly soluble in the frying oil.

In embodiments, the catalyst may be provided in the form of unsupported bulk particles.

In embodiments, at least part of the catalyst may be provided on a surface of at least one supporting structure or substrate. A material of the at least one supporting structure or substrate may, but need not, be insoluble or poorly soluble in the frying oil.

In another aspect of the present disclosure, a system for reducing degradation of a frying oil comprises a vessel; and disposed within the vessel, a plurality of particles of a catalyst selected from the group consisting of zinc metal, chloride salts of zinc or tin, oxide salts of zinc or tin, sulfate salts of zinc or tin, and combinations thereof, wherein the vessel is configured to receive the frying oil and heat the frying oil to a temperature from about 120° C. to about 200° C.

In embodiments, at least a portion of the particles may be unsupported bulk particles.

In embodiments, at least a portion of the particles may be provided as a coating on at least one supporting structure or substrate. The at least one supporting structure or substrate may, but need not, be selected from the group consisting of a porous zeolitic bead, an alumina support, a zirconia support, a silica support, a titania support, a ceramic support, a glass surface, a nanoscale porous ceramic fiber, a wire mesh, a rod, and a component or portion thereof of a frying device, system, or vessel. An average pore size of the at least one supporting structure or substrate may, but need not, be from about 0.25 mm to about 25 mm. A material of the at least one supporting structure or substrate may, but need not, be insoluble or poorly soluble in the frying oil. The at least one supporting structure or substrate may, but need not, comprise a porous sodium aluminosilicate zeolite structure. At least a portion of the coating may, but need not, be a monoatomic or monomolecular layer.

In embodiments, an average pore size of the catalyst particles may be from about 0.4 nm to about 1,500 μm.

In embodiments, the catalyst may be insoluble or poorly soluble in the frying oil.

In embodiments, the vessel may be further configured to promote the catalyst by imparting energy other than heat to the catalyst. The imparting step may, but need not, be selected from the group consisting of agitating the catalyst (or otherwise ensuring convective flow of the frying oil about and around the catalyst), exposing the catalyst to ultraviolet light, and combinations thereof.

In another aspect of the present disclosure, a method for reducing degradation of a frying oil comprises (a) contacting the frying oil with a catalyst selected from the group consisting of zinc metal, chloride salts of zinc or tin, oxide salts of zinc or tin, sulfate salts of zinc or tin, and combinations thereof and (b) maintaining the frying oil at a temperature from about 120° C. to about 200° C. during step (a).

In embodiments, the method may further comprise (c) contacting the frying oil with an adsorbent selected from the group consisting of a functionalized silica gel, an unfunctionalized silica gel, and combinations thereof. The adsorbent may, but need not, comprise a silica gel functionalized with aminopropyl groups, octadecyl groups, or combinations thereof. The silica gel may, but need not, be in the form of beads having an average bead size from about 0.25 mm to about 4 mm. The frying oil and the adsorbent may, but need not, remain in contact continuously for a period of about two hours to about twelve hours. Step (c) may, but need not, be carried out for a predetermined period, and, at the end of the predetermined period, the frying oil may, but need not, comprise no more than about 25 wt % polar compounds. The frying oil may, but need not, comprise no more than about 25 wt % polar compounds at all times during the predetermined period. Food may be fried in the frying oil contained in the frying vessel during all, some, or none of a duration of step (c). Step (a) may begin before, at the same time, or after step (c) begins and/or may end before, at the same, or after step (c) ends.

In embodiments, a vessel in which step (a) is carried out may be free of addition of any exogenous reactant.

In embodiments, the frying oil and the catalyst may remain in contact continuously for a period of at least about three hours, at least about six hours, at least about nine hours, at least about twelve hours, at least about eighteen hours, at least about one day, at least about two days, at least about three days, at least about four days, at least about five days, at least about six days, or at least about seven days.

In embodiments, step (a) may be carried out for a predetermined period, and, at the end of the predetermined period, at least one of the following may be true: (i) the frying oil comprises no more than about 3 wt % free fatty acids; (ii) the frying oil comprises no more than about 18 wt % monoglycerides; (iii) the frying oil comprises no more than about 15 wt % diglycerides; and (iv) the frying oil comprises at least about 60 wt % triglycerides. At least one of (i), (ii), (iii), and (iv) may, but need not, be true at all times during the predetermined period.

In embodiments, step (a) may prevent, or decrease the rate of, an autooxidation reaction.

In embodiments, step (a) may be carried out in a frying vessel and food may be fried in the frying oil contained in the frying vessel during at least part of a duration of step (a). Food may be fried in the frying oil contained in the frying vessel during all, some, or none of the duration of step (a).

In embodiments, the temperature may be from about 150° C. to about 190° C. The temperature may, but need not, be about 170° C.

In embodiments, steps (a) and (b) may be carried out at an ambient pressure of no more than about 1 atm. The ambient pressure may, but need not, be from about 90 kPa to about 1 atm.

In embodiments, the catalyst may be selected from the group consisting of zinc metal, zinc chloride (ZnCl₂), zinc oxide (ZnO), zinc sulfate heptahydrate (ZnSO₄·7H₂O), tin(II) chloride dihydrate (SnCl₂·2H₂O), tin(IV) chloride pentahydrate (SnCl₄·5H₂O), and combinations thereof.

In embodiments, at an outset of step (a), a molar ratio of glycerol to free fatty acids in the frying oil may be between about 0.5 and about 2.0. At the outset of step (a), the molar ratio of glycerol to free fatty acids in the frying oil may, but need not, be about 1.0.

In embodiments, the catalyst is present may be present an amount from about 0.05 wt % to about 1.5 wt % of a total weight of the frying oil.

In embodiments, the catalyst may be insoluble or poorly soluble in the frying oil.

In embodiments, at least part of the catalyst may be provided on a surface of at least one supporting structure or substrate. The at least one supporting structure or substrate may, but need not, comprise at least one of a porous zeolitic bead, an alumina support, a zirconia support, a silica support, a titania support, a ceramic support, a glass surface, a nanoscale porous ceramic fiber, a wire mesh, a rod, a honeycomb structure, a structure having many pores or channels with round or polygonal cross-sections, a sphere, a plate, a tube, and a random geometric structure. The at least one supporting structure or substrate may, but need not, comprise yttria-stabilized zirconia.

In another aspect of the present disclosure, a system for reducing degradation of a frying oil comprises a frying vessel; and disposed within the frying vessel, a plurality of particles of a catalyst selected from the group consisting of zinc metal, chloride salts of zinc or tin, oxide salts of zinc or tin, sulfate salts of zinc or tin, and combinations thereof, wherein the frying vessel is configured to receive the frying oil and heat the frying oil to a temperature from about 120° C. to about 200° C.

In embodiments, the system may further comprise an adsorbent selected from the group consisting of a functionalized silica gel, an unfunctionalized silica gel, and combinations thereof, and at least one of the following may be true: (i) the adsorbent is disposed within the frying vessel; and (ii) the system further comprises a holding vessel and at least a portion of the adsorbent is disposed within the holding vessel. The adsorbent may, but need not, comprise a silica gel functionalized with aminopropyl groups, octadecyl groups, or combinations thereof. The silica gel may, but need not, be in the form of beads having an average bead size from about 0.25 mm to about 4 mm.

In embodiments, at least a portion of the particles may be provided as a coating on at least one supporting structure or substrate. The at least one supporting structure or substrate may, but need not, comprise at least one of a porous zeolitic bead, an alumina support, a zirconia support, a silica support, a titania support, a ceramic support, a glass surface, a nanoscale porous ceramic fiber, a wire mesh, a rod, a honeycomb structure, a structure having many pores or channels with round or polygonal cross-sections, a sphere, a plate, a tube, and a random geometric structure. An average pore size of the at least one supporting structure or substrate may, but need not, be from about 0.25 mm to about 25 mm. The at least one supporting structure or substrate may, but need not, comprise yttria-stabilized zirconia. At least a portion of the coating may, but need not, be a monoatomic or monomolecular layer.

In embodiments, an average pore size of the catalyst particles may be from about 0.4 nm to about 1,500 μm.

In embodiments, the catalyst may be insoluble or poorly soluble in the frying oil.

In embodiments, the frying vessel may be further configured to promote the catalyst by imparting energy other than heat to the catalyst. The imparting step may, but need not, be selected from the group consisting of agitating the catalyst, exposing the catalyst to ultraviolet light, and combinations thereof.

While specific embodiments and applications have been illustrated and described, the present disclosure is not limited to the precise configuration and components described herein. Various modifications, changes, and variations which will be apparent to those skilled in the art may be made in the arrangement, operation, and details of the methods and systems disclosed herein without departing from the spirit and scope of the overall disclosure.

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 600 or as much as 900, or any value therebetween. When used in relation to ratios or relationships between two or more numerical limitations or ranges, the terms “about,” “approximately,” etc. mean that each of the limitations or ranges may vary by up to 20%; by way of non-limiting example, a statement that two quantities are “approximately equal” can mean that a ratio between the two quantities is as little as 0.8:1.2 or as much as 1.2:0.8 (or any value therebetween), and a statement that a four-way ratio is “about 5:3:1:1” can mean that the first number in the ratio can be any value of at least 4.0 and no more than 6.0, the second number in the ratio can be any value of at least 2.4 and no more than 3.6, and so on.

The embodiments and configurations described herein are neither complete nor exhaustive. As will be appreciated, other embodiments are possible utilizing, alone or in combination, one or more of the features set forth above or described in detail below.

### BRIEF DESCRIPTION OF THE DRAWINGS

FIG. 1A is a diagram illustrating one embodiment of a re-esterification method according to the present disclosure for real-time, continuous, in situ reduction in the rate of frying oil degradation.

FIG. 1B is a diagram illustrating another embodiment of a re-esterification method according to the present disclosure for real-time, continuous, in situ reduction in the rate of frying oil degradation.

FIG. 2 is a diagram illustrating an embodiment of a hybrid re-esterification/TPM adsorption method according to the present disclosure.

FIG. 3A is an illustration of a reaction scheme for esterification of glycerol and a fatty acid into a monoglyceride.

FIG. 3B is an illustration of a reaction scheme for esterification of a monoglyceride and a fatty acid into a diglyceride.

FIG. 3C is an illustration of a reaction scheme for esterification of a diglyceride and a fatty acid into a triglyceride.

### DETAILED DESCRIPTION

Unless defined otherwise, all technical and scientific terms used herein have the same meaning as is commonly understood by one of ordinary skill in the art. All patents, applications, published applications, and other publications to which reference is made herein are incorporated by reference in their entirety. If there is a plurality of definitions for a term herein, the definition provided in the Summary prevails unless otherwise stated.

Unless otherwise specified, any reference herein to a metal salt encompasses both the anhydrous form of such salt and any hydrates of such salt.

As used herein, unless otherwise specified, the term “active system” refers to any system for reducing degradation of frying oil, or any sub-system or process unit thereof, that alters the chemistry of the frying oil by removing and/or reusing oil-soluble chemical compounds. “Active systems,” as that term is used herein, may, but do not necessarily, remove particulate matter from the frying oil as a secondary function. Unless otherwise specified, the term “active system” is to be construed in this disclosure as contrasting and mutually exclusive with the term “passive system,” as that term is defined below.

As used herein, unless otherwise specified, the term “inert,” when applied to a re-esterification catalyst, a support structure or substrate on which the re-esterification catalyst is disposed, and/or a TPM absorbent or adsorbent material, means that the material referred to has no or very little tendency to induce, cause, catalyze, or accelerate a frying oil degradation reaction under typical frying conditions. Thus, for example, a frying oil can remain in contact with an “inert” structured catalyst and/or an “inert” TPM absorbent or adsorbent under frying conditions for a prolonged period (in many cases, at least about 30 days) without any significant increase in the rate of any oil degradation reaction relative to maintaining the frying oil under the same frying conditions in the absence of the structured catalyst.

As used herein, unless otherwise specified, the term “in situ” refers to an activity or process step, such as a chemical reaction, that is carried out entirely in the same location as a food frying operation, preferably in the same device or vessel as the food frying operation, but not necessarily while a food frying operation is ongoing. By way of non-limiting example, any reference herein to in situ re-esterification of frying oil degradation byproducts, unless otherwise specified, means that the re-esterification reaction(s) is/are taking place in the same location as a food frying operation (i.e., do not require the frying oil to be retrieved or removed from the frying facility, such as a restaurant), and preferably is/are taking place in the frying device or vessel itself, although they may also take place in an adjacent or nearby vessel in the same facility. Embodiments of in situ re-esterification methods and systems include those in which re-esterification is carried out in the frying device or vessel and/or in a separate process vessel; in the latter case, oil may be conveyed between a frying vessel and the process vessel manually (e.g., by being poured by an operator) or automatically (e.g., by a pump which may be computer-controlled, timer-controlled, etc.).

As used herein, unless otherwise specified, the term “passive system” refers to any system for reducing degradation of frying oil, or any sub-system or process unit thereof, that does not significantly affect, alter, or interact with the chemistry of the frying oil. In most cases, “passive systems,” as that term is used herein, attempt to reduce degradation of frying oil only by removing insoluble particulate matter from the frying oil. Unless otherwise specified, the term “passive system” is to be construed in this disclosure as contrasting and mutually exclusive with the term “active system,” as that term is defined above.

As used herein, unless otherwise specified, the terms “real-time” and “in real time” each refer to an activity or process step, such as a chemical reaction, that is carried out in a frying oil while the frying oil is at frying temperature, or being heated to or cooled from frying temperature. By way of non-limiting example, any reference herein to real-time re-esterification of frying oil degradation byproducts, unless otherwise specified, means that the re-esterification reaction(s) is/are taking place in the frying oil while the frying oil is at frying temperature, or being heated to or cooled from frying temperature.

As used herein, unless otherwise specified, the term “stable” and its derived terms (e.g., “stability”), when applied to a re-esterification catalyst, a support structure or substrate on which the re-esterification catalyst is disposed, and/or a TPM absorbent or adsorbent material, means that the material referred to, under frying conditions and while in contact with a frying oil, (1) is insoluble or poorly soluble in the frying oil, and (2) has sufficient hardness and/or resistance to friability to resist “dusting” or “shedding” due to contact or abrasion by other catalyst substrate material(s). Thus, for example, a frying oil can remain in contact with a “stable” structured catalyst under frying conditions for a prolonged period (in many cases, at least about 30 days) without any significant increase in the concentration of dissolved and/or free particles of the catalyst material(s) and/or the material(s) of the support structure or substrate in the frying oil.

As used herein, unless otherwise specified, the term “structured catalyst” refers to an apparatus or device that comprises a re-esterification catalyst supported on a surface of a scaffold or substrate. One non-limiting example of a “structured catalyst” as that term is used herein is an apparatus or device comprising zinc oxide (a re-esterification catalyst) as a surface coating or layer of an yttria-stabilized zirconia substrate.

To comply with applicable written description and enablement requirements, the following documents are incorporated herein by reference in their entireties:

British Patent Application Publication 712,747, entitled “Improvements in and relating to preparations of fatty acid esters,” published 28 Jul. 1954 to Schlueter.

U.S. Pat. No. 3,947,602, entitled “Treatment of cooking oil,” issued 30 Mar. 1976 to Clewell et al.

U.S. Pat. No. 4,112,129, entitled “Cooking oil treatment system and composition therefor,” issued 5 Sep. 1978 to Duensing et al.

U.S. Pat. No. 5,348,755, entitled “Extension of edible oil lifetime using activated carbons,” issued 20 Sep. 1994 to Roy.

U.S. Pat. No. 5,433,841, entitled “Method for reforming hydrocarbons,” issued 18 Jul. 1995 to Ichikawa.

U.S. Pat. No. 6,147,196, entitled “Process for producing esters of fatty substances and the high purity esters produced,” issued 14 Nov. 2000 to Stern et al.

PCT Application Publication 2005/063954, entitled “Improved process for preparing fatty acid alkylesters using as biodiesel,” published 14 Jul. 2005 to Gupta et al.

U.S. Pat. No. 7,597,044, entitled “Devices for reforming frying oil,” issued 6 Oct. 2009 to Oh.

Chinese Patent Application Publication 102453613, entitled “Method for producing diesel oil by esterification deacidification of rice bran oil,” published 16 May 2012 to Ang.

U.S. Pat. No. 10,974,180, entitled “Cooking oil treatment filtration aid and method,” issued 13 Apr. 2021 to Trent et al.

U.S. Pat. No. 11,028,337, entitled “Structure including rice hull ash and reinforcing binder for adsorbing contaminants from cooking oil,” issued 8 Jun. 2021 to Chapman.

The methods and systems of the present disclosure enable real-time, continuous, in situ reduction in the rate of frying oil degradation by reducing the accumulation of undesirable oil breakdown byproducts. Particularly, the methods and systems of the present disclosure reduce the rate of accumulation of undesirable compounds such as FFAs and TPMs, keeping the levels of these undesirable compounds in the frying oil below industry-accepted thresholds at which food quality is negatively impacted and below levels that cause accelerated degradation of the oil. This effect, in turn, substantially extends the useful life of the frying oil and improves the quality of foods fried in the oil relative to currently available techniques. Use of the methods and systems of the present disclosure may also provide further advantages and benefits, such as reduced labor costs and improvements in worker safety.

Most typically, systems according to the present disclosure are “hybrid” systems that include two sub-systems, a catalytic sub-system and an adsorption sub-system, the structures and functions of each of which are described in further detail throughout this disclosure. In the practice of the concepts described in this disclosure, catalytic sub-systems are primarily (though not necessarily exclusively) responsible for reducing FFA content, mitigating accumulation of mono- and diglycerides, maintaining a high triglyceride content, and reducing the rate of autooxidation reactions, while the adsorption sub-system is primarily (though not necessarily exclusively) responsible for mitigating accumulation and/or reducing the content of TPMs and improving oil viscosity, clarity, and/or color. Importantly, both catalytic sub-systems and adsorption sub-systems as disclosed herein are “active” systems (as that term is used herein); this stands in contrast to “passive” systems that have no significant effect on the chemistry of the frying oil and attempt to reduce degradation of the oil only by non-chemical interventions (e.g., mechanically removing oil-insoluble particulates from the frying oil).

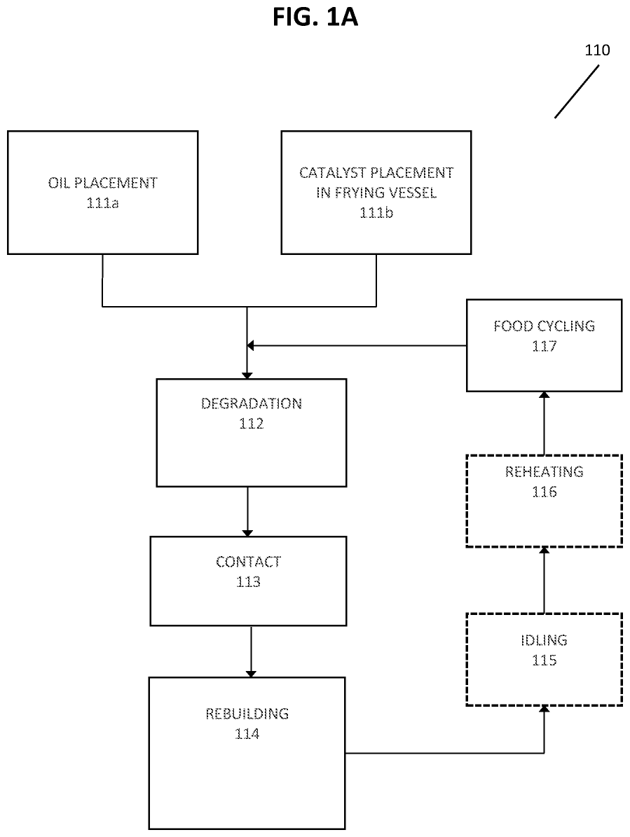

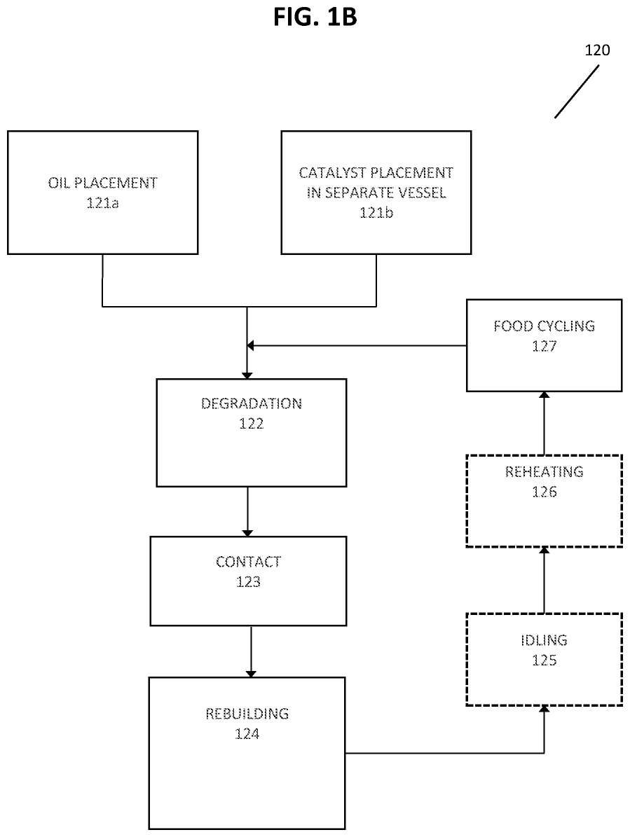

Referring now to FIG. 1A, a first embodiment of a method 110 for the real-time, continuous, in situ reduction in the rate of frying oil degradation is illustrated. In initial placement step 111a and 111b, heated frying oil and a catalytic device, respectively, are placed inside a frying vessel; it is to be expressly understood that placement steps 111a and 111b may be carried out simultaneously or sequentially in any order, so long as after both steps are completed, the catalytic device is in continuous contact with the frying oil inside the frying vessel. In degradation step 112, the frying oil, due to being heated to a frying temperature and maintained at such temperature for some period (and, optionally, also due to the presence of water molecules in food being fried in the frying oil), degrades by oxidation and hydrolysis reactions to form FFAs and TPMs in the frying oil. In contact step 113, molecules of oil degradation byproducts (e.g., glycerol, mono- and diglycerides, FFAs, and TPMs) physically contact catalyst particles on the surface of the catalytic device. In rebuilding step 114, oil degradation byproduct molecules, due to their physical interaction with the catalyst, undergo re-esterification and are thereby rebuilt into triglycerides, the original and desired main component of the frying oil. In optional idling step 115 and optional reheating step 116, the frying oil may be cooled (e.g., to room temperature or to a “holding” temperature that is above room temperature but below frying temperature) during an “idle” period and then reheated to resume a frying process. In food cycling step 117, food that was present in the frying oil during original degradation step 112 may be removed from the frying oil and/or a new batch of food to be fried may be added to the frying oil, and a new frying cycle may thus begin. As illustrated in FIG. 1A, degradation step 112, contact step 113, rebuilding step 114, optional idling step 115, optional reheating step 116, and food cycling step 117 may collectively be repeated any number of times, i.e., the method 110 may be effective to rebuild oil degradation byproducts into triglycerides over the course of many consecutive frying cycles without disposal or replacement of the frying oil.

Referring now to FIG. 1B, a second embodiment of a method 120 for the real-time, continuous, in situ reduction in the rate of frying oil degradation is illustrated. The method 120 illustrated in FIG. 1B is substantially identical to the method 110 illustrated in FIG. 1A, except that the catalytic device, rather than being placed inside the frying vessel (as in step 111b of method 110), is instead (in step 121b of method 120) placed in a separate vessel but is nonetheless in continuous contact with oil removed from a frying vessel, e.g., by being poured by an operator or by a pump. The oil removed from the frying vessel in method 120 and re-esterified in step 124 can then be returned to the frying vessel for further use in the frying process. The steps of method 120 illustrated in FIG. 1B are otherwise analogous to the steps of the method 110 illustrated in FIG. 1A, and as illustrated in FIG. 1B, degradation step 122, contact step 123, rebuilding step 124, optional idling step 125, optional reheating step 126, and food cycling step 127 may collectively be repeated any number of times, i.e., the method 120 may be effective to rebuild oil degradation byproducts into triglycerides over the course of many consecutive frying cycles without disposal or replacement of the frying oil.

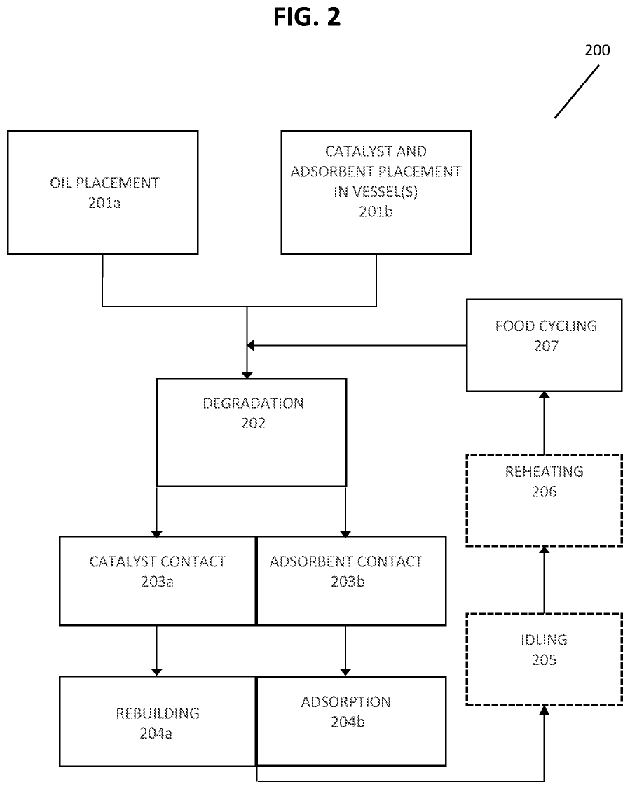

Referring now to FIG. 2, an embodiment of a hybrid re-esterification/TPM adsorption method 200 is illustrated. The method 200 illustrated in FIG. 2 is similar to the methods 110 and 120 illustrated in FIGS. 1A and 1B (and thus, it should be noted, the catalytic device can be placed either in the frying vessel as in step 111b of method 110 or in a separate vessel as in step 121b of method 120), except that the placement step 201b involves placement of both a re-esterification catalyst and a TPM adsorbent. As a result, the contact step 203 includes both a catalyst contact sub-step 203a and an adsorbent contact sub-step 203b, and, in addition to degradation byproduct molecules undergoing re-esterification and thereby being rebuilt into triglycerides in rebuilding sub-step 204a, TPMs are adsorbed and removed from the frying oil in adsorption sub-step 204b. The steps of method 200 illustrated in FIG. 2 are otherwise analogous to the steps of the method 110 illustrated in FIG. 1A and/or the steps of the method 120 illustrated in FIG. 1B, and as illustrated in FIG. 2, degradation step 202, catalyst contact step 203a, adsorbent contact sub-step 203b, rebuilding sub-step 204a, adsorption sub-step 204b, optional idling step 205, optional reheating step 206, and food cycling step 207 may collectively be repeated any number of times, i.e., the method 200 may be effective to rebuild oil degradation byproducts into triglycerides and adsorb TPMs from the frying oil over the course of many consecutive frying cycles without disposal or replacement of the frying oil.

In some embodiments, depending on the adsorbent material used in adsorbent contact sub-step 203b and adsorption sub-step 204b, a temperature at which, or temperature range within which, adsorption of TPMs is maximized (i.e., the binding energy of TPMs to the adsorbent material is high enough for TPMs to be retained by the adsorbent material to the greatest extent possible) may be below frying temperature; by way of non-limiting example, for some combinations of adsorbent material and frying operation considerations, the adsorbent material may be most effective at temperatures of between about 50° C. and about 150° C. (or within any subrange thereof), whereas frying operations may need to be carried out at a temperature of about 170° C. In these embodiments, adsorbent contact sub-step 203b and/or adsorption sub-step 204b may be carried out as part of, or take the place of, idling step 205; in other words, the frying oil may contact the adsorbent and/or TPMs may be adsorbed from the frying oil onto the adsorbent material while or after the frying oil is cooled (to room temperature, or to a temperature higher than room temperature but below frying temperature) during an “idle” period. In some such embodiments, adsorbent contact sub-step 203b may comprise placing an adsorber “cartridge” or similar apparatus and/or device comprising the adsorbent material into a frying vessel during an “idle” period so that as the oil cools, its temperature is within the ideal adsorption temperature range such that TPMs can be adsorbed and captured from the frying oil to the greatest extent possible. The adsorber “cartridge” or similar apparatus and/or device can then be removed from the frying vessel before the oil is then reheated to frying temperature in heating step 206, and the adsorbent material can be regenerated as further described elsewhere throughout this disclosure such that it is ready to be returned to service in another frying cycle. This cycle of adsorbent placement, activity, removal, and regeneration can be repeated many times with a single adsorber “cartridge” or similar apparatus and/or device, thereby greatly reducing the quantity of waste generated relative to alternative techniques that utilize disposable single-use adsorbents.

### Real-Time, Continuous Catalytic Re Esterification

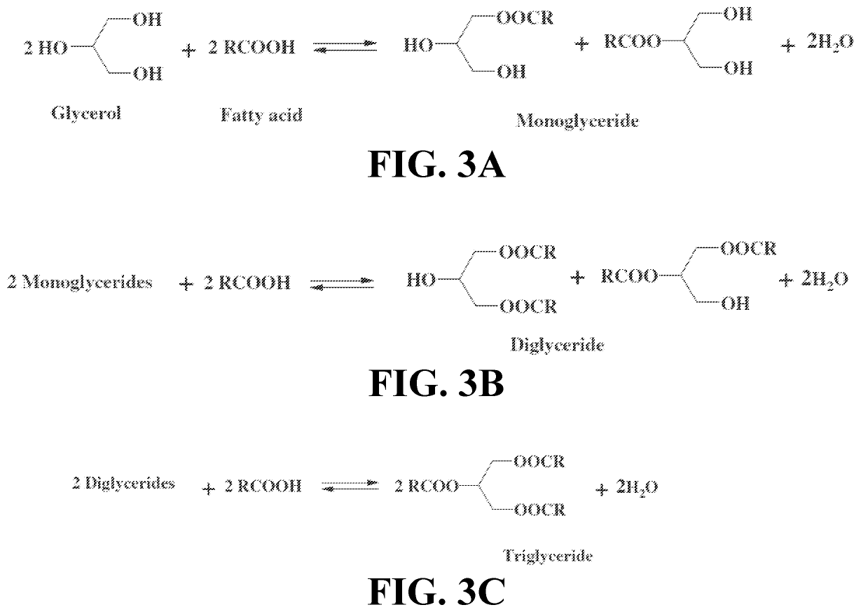

The methods and systems of the present disclosure rebuild, reconstruct, and/or produce triglycerides in frying oils by re-esterifying degradation byproducts in the oils, i.e., free fatty acids (FFAs), glycerol, and mono- and diglycerides, which are continuously generated within the frying oil when the oil is heated to frying temperature (both during the frying of food and during “idle” or “down” time of a frying vessel), using a suitable Lewis acid catalyst. More specifically, the use of this catalyst enables one or more of (i) the esterification of glycerol and FFAs into monoglycerides (as illustrated in FIG. 3A), (ii) the esterification of monoglycerides and FFAs into diglycerides (as illustrated in FIG. 3B), and/or (iii) the esterification of diglycerides and FFAs into triglycerides (as illustrated in FIG. 3C) in the frying oil. Most preferably, if sufficient glycerol is available in the frying oil, all three reaction steps illustrated in FIGS. 3A through 3C may occur, such that triglycerides (the primary constituent of fresh/unused frying oils) are reconstituted from FFAs.

The use of the methods and systems of the present disclosure enables the re-esterification of FFAs, as illustrated in FIGS. 3A through 3C, at temperatures from about 120° C. to about 200° C., which are typically achieved in many frying operations. The esterification reactions are endothermic and therefore the esterification products are increasingly favored with higher temperature, with relatively little conversion of FFAs into monoglycerides at temperatures below about 130° C., predominant production of monoglycerides as the temperature increases above 130° C., and then increasing production of di- and triglycerides as the temperature further increases toward 200° C. However, neither the relationship between temperature and selectivity of triglyceride production nor the real-time rate of re-esterification under any given set of process conditions is the same for all catalysts. Triglyceride selectivity and real-time re-esterification rate under any given set of process conditions may also be affected by the physical structure or chemical composition of the substrate on which the catalyst may be provided. Thus, one advantage and benefit of the present disclosure is that skilled artisans can, using the teachings disclosed herein, optimize re-esterification process parameters to select a desired re-esterification profile and achieve optimal mitigation of oil breakdown byproducts while remaining within a desired range of fryer operating temperatures, temperatures within the range of 150 to 190° C. generally being most preferred.

Without adequate mitigation, FFA and TPM levels in a frying oil typically rise rapidly during a commercial or industrial frying operation; by way of non-limiting example, the FFA and TPM levels in a frying oil may rise to at least about 2.5 wt % and at least about 25 wt %, respectively, within about three days of typical frying operations, and if the food being fried is a frozen product with a high protein content (e.g., frozen chicken or other frozen meat), these levels may even be substantially higher (i.e., the oil may degrade even faster). Unmitigated degradation also typically entails undesirable increases in mono- and diglyceride contents and an undesirable decrease in triglyceride content. As a result, in the absence of mitigation of oil degradation, the oil may degrade beyond acceptable regulatory and/or consumer appeal limits in a matter of days or even hours. The methods and systems of the present disclosure thus significantly extend the useful life of frying oils by mitigating, and in many embodiments even reversing and/or remediating, degradation of the oil.

Methods and systems of the present disclosure use a Lewis acid catalyst to catalyze real-time, in situ re-esterification of the oil breakdown byproducts in the frying oil into triglycerides. Most typically (but not exclusively), the Lewis acid catalyst includes zinc metal and/or at least one chloride, oxide, or sulfate salt of zinc or tin (in anhydrous or hydrated form), including but not limited to zinc chloride (ZnCl₂), zinc oxide (ZnO), zinc sulfate heptahydrate (ZnSO₄·7H₂O), tin(II) chloride dihydrate (SnCl₂·2H₂O), and tin(IV) chloride pentahydrate (SnCl₄·5H₂O). Other non-limiting examples of Lewis acid catalysts that may be useful in the practice of the methods and systems disclosed herein include salts, and especially halides, of aluminum, boron, copper, iron, silicon, tin, titanium, or zirconium.

Methods and systems of the present disclosure may be effective to maintain the FFA content of frying oils at advantageously low levels, and particularly at levels that comply with applicable regulatory requirements and do not adversely affect the quality of the fried food or accelerate autooxidation processes in the oil, for extended periods. In some embodiments, the FFA content of a frying oil to which a device, method, and/or system as disclosed herein is applied is maintained below a certain threshold level, e.g., no more than about 3 wt % or between about 2 wt % and about 3 wt %, for a continuous period of at least about one day, at least about two days, at least about three days, at least about four days, at least about five days, at least about six days, at least about seven days, at least about eight days, at least about nine days, at least about ten days, at least about eleven days, at least about twelve days, at least about thirteen days, at least about fourteen days, at least about fifteen days, at least about sixteen days, at least about seventeen days, at least about eighteen days, at least about nineteen days, at least about twenty days, at least about 21 days, at least about 22 days, at least about 23 days, at least about 24 days, at least about 25 days, at least about 26 days, at least about 27 days, at least about 28 days, at least about 29 days, or at least about 30 days at frying temperatures.

The methods and systems of the present disclosure represent an important and significant advance over the current state of the art in that they enable re-esterification of oil breakdown byproducts (i.e., glycerol, FFAs, and mono- and diglycerides) into triglycerides in situ (that is, without removing the frying oil from the location where the frying operation is taking place (e.g., by transferring the frying oil from a frying vessel to an adjacent or nearby process vessel for re-esterification), and preferably without removing it from the frying device or vessel) and in real time (that is, during ongoing use of the frying oil in the frying operation, without requiring pause or shutdown of the frying operation). The advantages and benefits of real-time in situ re-esterification may be achieved by selecting an appropriate catalyst and an appropriate set of frying operation process parameters to continuously mitigate the accumulation of undesirable oil breakdown byproducts.

Another advantage of the real-time in situ re-esterification methods and systems of the present disclosure is that it is not necessary to physically or chemically separate any species or phases from each other during the frying operation, e.g., by decantation, distillation, evaporation, filtration, etc. Rather, because all of the materials used and all intermediates and byproducts of the re-esterification reaction(s) are food-safe, food can continue to be fried in the same vessel even while the methods and systems of the present disclosure are being carried out, without removal of any part of the frying oil or catalyst. This represents a distinct advantage over conventional techniques, which may require dangerous, difficult, energy-intensive, and/or time-consuming steps. By way of first non-limiting example, methods and systems of the present disclosure may not require filtration of the catalyst or a reaction byproduct (e.g., mono-alcohols, fatty acid methyl esters, or other unwanted organic species) from the frying oil, which is difficult, requires specialized equipment, and necessitates either interruption of the frying operation to allow the oil to cool or a potential burn hazard to employees if carried out while the oil is hot. By way of second non-limiting example, methods and systems of the present disclosure do not necessitate distillation or fractionation of any frying oil species, which requires significant energy inputs and specialized equipment (high-pressure vessels, columns, etc.).

Still another advantage of the real-time in situ re-esterification methods and systems of the present disclosure is that they may allow for either continuous or batch operations. Particularly, in almost all restaurants and commercial frying operations, fryers are left on (i.e., maintaining the frying oil at frying temperature) continuously throughout the business day, and in some industrial or other 24-hour operations for many days on end. Techniques for the mitigation or prevention of oil degradation that require frequent interruptions to the frying operation are therefore unacceptable, or at least inconvenient and disfavored. Because they allow for catalytic re-esterification in situ, with no or minimal human intervention once initiated, the methods and systems of the present disclosure address this issue by remaining effective to mitigate or prevent oil degradation without interruption for many consecutive frying “runs,” and in some embodiments essentially indefinitely, or at least for as long as the catalyst is not fouled or saturated. Even in those embodiments in which the in situ re-esterification methods and systems of the present disclosure are not applied in the frying vessel itself but are instead carried out in a separate vessel adjacent or near to the frying vessel, continuous operations may still be enabled, for example by providing two volumes of frying oil that may be exchanged as needed (i.e., with one volume of oil being used for the frying operation while another undergoes re-esterification/rebuilding of triglycerides in the adjacent or nearby vessel, such that the volumes of oil can be exchanged when the first volume of oil is ready for re-esterification/rebuilding of triglycerides).

Yet another advantage of the methods and systems of the present disclosure is that in many embodiments they do not require any reactants that are not already present in the frying oil to effect re-esterification. Stated slightly differently, embodiments of the methods and systems of the present disclosure do not require the addition to the reaction vessel of any reactants exogenous to the frying oil, e.g., mono-alcohols or other organic materials. This advantage reduces operational complexities and costs and the potential for contamination of the oil or fried food. Additionally, because the methods and systems of the present disclosure are effective to re-esterify frying oils regardless of whether food is present in the oil, they can enable continuous reduction in the degradation rate of the oil both during frying operations and during “idle” or “down” time, i.e., when frying equipment is not being used to fry food.

### Process Parameters

While the reduction of FFAs in the frying oil is one important process objective, others include the desired triglyceride content in the frying oil and the desired TPM content in the frying oil, and skilled artisans can, using the teachings disclosed herein, select an appropriate catalyst and an appropriate set of process conditions for achieving these objectives. By way of non-limiting example, the present inventors have found that the use of tin(II) chloride (SnCl₂) as a re-esterification catalyst results in a greater content of ω-3 fatty acids in the frying oil compared to zinc oxide, and that zinc oxide (ZnO) may yield lower total FFA content and increased triglyceride content in the frying oil than zinc chloride (ZnCl₂) or tin(II) chloride (SnCl₂). As a result, a skilled artisan can select a desired catalyst or combination of catalysts, as well as a catalyst concentration, frying operation process parameters (e.g., frying temperature, ratio of glycerol to fatty acids in the frying oil, etc.), and a catalyst structure, to achieve combinations of various process objectives (e.g., triglyceride yield, fatty acid composition of the frying oil, etc.).

One important consideration in the use of methods and systems disclosed herein is the glycerol content of the frying oil. As illustrated in FIG. 3A, glycerol is a necessary building block for the re-esterification of FFAs into monoglycerides, which in turn can be re-esterified with additional FFAs into diglycerides, which in turn can be re-esterified with additional FFAs into triglycerides. In some embodiments, therefore, glycerol may be added to the frying oil, either before (i.e., to the fresh oil) or during (i.e., after at least some breakdown of the oil has occurred) the frying operation, but it is to be expressly understood that in many other embodiments, the glycerol produced endogenously by breakdown/degradation of the frying oil will be sufficient for re-esterification into triglycerides and supplementation of additional glycerol will not be necessary. In some embodiments of the methods and systems of the present disclosure, a molar ratio of glycerol to total FFAs may be controlled or selected (e.g., by selecting a frying oil having the desired ratio, by adding glycerol to the frying oil, and/or by supplementing or replacing the frying oil or a portion thereof during the frying operation with a different oil having a higher or lower molar ratio of glycerol to FFAs), and may particularly be from about 0.5 to about 2.0, or from about 0.6 to about 1.8, or from about 0.7 to about 1.6, or from about 0.8 to about 1.4, or from about 0.9 to about 1.2, or about 1.0, or alternatively in any range having a lower bound of any tenth of a whole number from 0.5 to 2.0 and an upper bound of any other tenth of a whole number from 0.5 to 2.0. The molar ratio of glycerol to FFAs in the frying oil may be, by way of non-limiting example, about 0.5, about 0.6, about 0.7, about 0.8, about 0.9, about 1.0, about 1.1, about 1.2, about 1.3, about 1.4, about 1.5, about 1.6, about 1.7, about 1.8, about 1.9, or about 2.0. The present inventors have found that in many applications, a molar ratio of glycerol to total FFAs of about 1.0 generally offers the most repeatable and consistent re-esterification performance.

In some embodiments, the catalyst may be provided as part of a fresh frying oil (or added to a frying vessel together with a fresh frying oil at the outset of a frying operation), while in other embodiments the catalyst may be provided separately and added to a frying oil already in use. In still further embodiments, both of these may be true, i.e. a second aliquot of catalyst may be added to an oil that contained a first aliquot of catalyst when fresh and has since been used in a frying operation for some length of time. Embodiments of this latter type may be particularly desirable where the desired re-esterification profile may change with time. By way of non-limiting example, because fresh frying oils generally contain very little FFA content, it may be desirable to provide a fresh frying oil with a first catalyst that is especially effective at re-esterifying diglycerides into triglycerides as the first FFAs are produced during frying, and then, as the oil ages (i.e. as glycerol, FFAs, and mono- and diglycerides begin to accumulate), to add a second catalyst that is especially effective at re-esterifying glycerol into monoglycerides and/or monoglycerides into diglycerides, such that the amounts of the starting materials of the reaction most effectively catalyzed by the first catalyst (i.e., re-esterification of diglycerides into triglycerides) are increased. Similarly, a catalyst may in some embodiments be left in (or in contact with) the oil for the duration of the life of the oil, while in other embodiments a catalyst may be removed from the oil at some point during the frying operation.

In embodiments of the methods and systems of the present disclosure, the catalyst may be provided at a concentration in the oil from about 0.05 wt % to about 1.5 wt %, or alternatively in any range having a lower bound of any twentieth of a weight percent from 0.05 wt % to 1.5 wt % and an upper bound of any other twentieth of a weight percent from 0.05 wt % to 1.5 wt %. The catalyst may in some embodiments be provided at a concentration of about 0.05 wt %, about 0.1 wt %, about 0.15 wt %, about 0.2 wt %, about 0.25 wt %, about 0.3 wt %, about 0.35 wt %, about 0.4 wt %, about 0.45 wt %, about 0.5 wt %, about 0.55 wt %, about 0.6 wt %, about 0.65 wt %, about 0.7 wt %, about 0.75 wt %, about 0.8 wt %, about 0.85 wt %, about 0.9 wt %, about 0.95 wt %, about 1.0 wt %, about 1.05 wt %, about 1.1 wt %, about 1.15 wt %, about 1.2 wt %, about 1.25 wt %, about 1.3 wt %, about 1.35 wt %, about 1.4 wt %, about 1.45 wt %, or about 1.5 wt %, or at any concentration lying between any two of these values. The present inventors have found that providing the catalyst at higher concentrations generally results in higher reaction rates but does not necessarily result in the highest performance overall when considering net FFA reduction and/or net triglyceride yields. Providing the catalyst at lower concentrations may also be desirable in certain applications for achieving a desired selectivity of triglyceride rebuilding/production and/or for controlling levels of total polar molecules (TPMs)/total polar compounds (TPCs).

In embodiments of the methods and systems of the present disclosure, an operating temperature (i.e., the temperature of the frying oil in the frying operation, and thus the temperature at which the catalytic re-esterification reactions are carried out) may be from about 120° C. to about 200° C., or alternatively in any range having a lower bound of any whole number of degrees Celsius from 120° C. to 200° C. and an upper bound of any other whole number of degrees Celsius from 120° C. to 200° C. By way of non-limiting example, a lower bound of the range of operating temperatures may be about 120° C., about 125° C., about 130° C., about 135° C., about 140° C., about 145° C., about 150° C., about 155° C., about 160° C., about 165° C., about 170° C., about 175° C., about 180° C., about 185° C., about 190° C., or about 195° C., and/or an upper bound of the range of operating temperatures may be about 200° C., about 195° C., about 190° C., about 185° C., about 180° C., about 175° C., about 170° C., about 165° C., about 160° C., about 155° C., about 150° C., about 145° C., about 140° C., about 135° C., about 130° C., or about 125° C. The nominal operating temperatures of most conventional commercial frying operations are between about 150° C. and about 190° C., and thus embodiments of the present disclosure may be carried out within, or close to, this range. As described in greater detail throughout this disclosure, the present inventors have carried out tests of various catalysts at temperatures from about 145° C. to about 195° C. and determined that an “optimal” temperature will generally depend on the chemical composition of the catalyst and its physical structure, but have found that for many catalysts, an operating temperature of about 170° C.—a temperature typical of and appropriate for most commercial frying operations and most types of frying oil—offers very favorable, and in at least some embodiments optimal, FFA reduction performance.

In embodiments of the methods and systems of the present disclosure, an operating pressure (i.e., the ambient pressure in the environment of the frying operation, and thus the ambient pressure at which the catalytic re-esterification reactions are carried out) may be about atmospheric pressure or may alternatively be a sub-atmospheric pressure. By way of non-limiting example, the operating pressure, and/or an upper bound of the range of operating pressures, may be about 101 kPa, about 100 kPa, about 99 kPa, about 98 kPa, about 97 kPa, about 96 kPa, about 95 kPa, about 94 kPa, about 93 kPa, about 92 kPa, about 91 kPa, about 90 kPa, about 80 kPa, about 70 kPa, about 60 kPa, about 50 kPa, about 40 kPa, about 30 kPa, about 20 kPa, about 10 kPa, about 9 kPa, about 8 kPa, about 7 kPa, about 6 kPa, about 5 kPa, about 4 kPa, about 3 kPa, about 2 kPa, about 1 kPa, a medium vacuum pressure (i.e., from about 100 mPa to about 3 kPa), a high vacuum pressure (i.e., from about 100 nPa to about 100 mPa), an ultra-high vacuum pressure (i.e., from about 100 pPa to about 100 nPa), or an extremely high vacuum pressure (i.e., less than about 100 pPa). Thus, while in some embodiments an at least partial vacuum may be applied such that the re-esterification reaction(s) is/are carried out at sub-atmospheric pressure (which may, depending on the catalyst and other operating parameters, provide improved catalyst performance or other advantages), in many embodiments no vacuum application is necessary and the methods and systems of the disclosure may be carried out at ambient pressures and/or without the need for pressure control, which may advantageously provide operational simplicity and reduced equipment and/or operating costs. A particular advantage is that the methods and systems of the present disclosure do not require high (that is, super-atmospheric) pressures, as the equipment needed to carry out frying operations under such pressures can be expensive and/or require special training to operate, and if operated improperly can represent a significant safety hazard. In some embodiments, it may also be beneficial to provide a nitrogen-rich ambient atmosphere, which may, by way of non-limiting example, be provided as a “blanket” of nitrogen gas covering and flowing over the top surface of the frying oil, while maintaining an atmospheric or sub-atmospheric operating pressure. This nitrogen “blanket” or other nitrogen-rich atmosphere can provide still further reductions in the accumulation of unwanted oxidation and hydrolysis byproducts.

The reaction kinetics and reaction endpoints of re-esterification in the practice of the methods and systems of the present disclosure will vary widely based on the chemical composition and physical structure of the catalyst and operating parameters of the frying operation. These characteristics of the re-esterification reaction(s) will also vary over time, i.e., at different time points even within the context of a single frying operation in which the catalyst composition and structure and operating parameters do not change. It is to be expressly understood that while in some embodiments (e.g., embodiments in which the frying operation may be carried out for a relatively short period, such as no more than about 24 hours) maximization of re-esterification kinetics may be desirable, in other embodiments (e.g., embodiments in which the frying operation may be carried out over a longer period, or even continuously and/or indefinitely), lower reaction rates may be acceptable or even desirable.

In some embodiments according to the present disclosure, a frying device and/or system may include functional and/or supportive components that are external to any oil vessels but are still interconnected to and integral with other components of the frying device and/or system. Non-limiting examples of such functional and/or supportive components electronics, sensors, warning systems, data generation devices, wireless communication devices, motors, and the like. In view of the present disclosure, those skilled in the art will understand how to select and incorporate such functional and/or supportive components into frying devices and/or systems according to embodiments of the present disclosure to provide additional operational efficiencies and quality control points.

In some embodiments, the spatial arrangement of the catalyst within a frying device and/or system (e.g., the location within the frying device and/or system in which a structured catalyst is installed or otherwise disposed) may be selected to ensure at least a desired degree of convective flow of frying oil about and around a surface of the catalyst. It is to be expressly understood, however, that convective flow of the frying oil inherently occurs during frying operations, and thus that placement of the catalyst (whether or not a structured catalyst) in a location that optimizes convective flow is not necessary to optimize catalyst efficiency in all embodiments.

### Catalytic Sub-System: Catalyst Parameters

While certain embodiments of the methods and systems disclosed herein may provide the re-esterification catalyst homogeneously with the frying oil (that is, with the catalyst and the frying oil substantially as a single phase, i.e., wherein the catalyst is substantially completely dissolved within the liquid frying oil), in most embodiments the re-esterification catalyst will be heterogeneous (that is, in a liquid or, more commonly, solid phase separate from the liquid frying oil). Heterogeneous catalysts for use in the practice of the methods and systems of the present disclosure may be provided in unstructured form (i.e. as a “bulk” or “free” material not affixed to any structure or substrate, which may in some embodiments have a particle size of about 50 μm to about 5 mm), but more typically is provided in structured form (i.e. affixed to the surface of a supporting structure or substrate). Parameters relating to the chemical composition and physical structure of the catalyst may be controlled, designed, optimized, selected, and/or tuned to provide desired characteristics of the re-esterification process, as described in greater detail throughout this disclosure.

One important parameter of solid catalysts suitable for use in the methods and systems of the present disclosure is the effective surface area of the catalyst, i.e., the total surface area of the catalyst that is, or can be, in direct contact with the frying oil. The total surface area of solid catalyst particles has an important effect on reaction rate, and in general, for a given mass of catalyst, the smaller the catalyst particle size, the larger the effective surface area. In some embodiments, the effective surface area of the catalyst may be maximized by providing the catalyst in structured form; a well-designed supporting structure or substrate may prevent or mitigate agglomeration and/or sintering of small catalyst particles, thereby exposing a greater surface area of the catalyst to the frying oil and increasing the specific activity of the catalyst. Particularly, to enhance the effective surface area of the supported catalyst and/or enhance the adhesion of catalyst particles on the surface thereof (and thus facilitate stability, as that term is defined herein, of the supported catalyst), the structure or substrate may have any suitable surface texture, e.g., smooth, nano-scale roughness, micro-scale roughness, porous or non-porous, etc. It is important, however, that maximization of the effective surface area of the catalyst and other spatial considerations of the catalyst and/or supporting structure or substrate do not undermine or come at the expense of the chemical stability of the catalyst under frying conditions or the “inert” nature of the catalyst and/or support material, as described further below.

While in some embodiments the support may merely be a structure or substrate to a surface of which the catalyst is affixed, in other embodiments the catalyst and the support may chemically interact to affect the catalytic reaction. Providing a supporting structure or substrate that itself has a high surface area-to-volume ratio may further enhance the effective surface area of the catalyst. In some embodiments, the catalyst may be provided as a coating, or otherwise affixed to a surface, of a replaceable component of a frying device, system, or vessel, such as, by way of non-limiting example a fryer basket; in this way, when the component reaches the end of its useful life (e.g., for a fryer basket, about six months), it may be replaced with a new component that likewise includes the catalyst, thereby ensuring regular replacement of the catalyst.

In some embodiments, at least a portion of the catalyst may be provided as a coating on any oil-facing surface of a frying device and/or vessel, e.g., surfaces of submersible fryer baskets, interior surfaces of pipes and other structures of an oil filtering and/or oil flow circulation system, etc. Thus, in some embodiments, the catalytic sub-system may be provided as part of new and/or retrofitted frying devices and systems, and frying devices and systems incorporating such a “built-in” catalytic sub-system are within the scope of the present disclosure.

Another important parameter of catalysts suitable for use in the methods and systems of the present disclosure is the diffusion profile of the catalyst and/or of the structure or substrate on which the catalyst is supported. The diffusion profile is, in turn, generally controlled by the total porosity and pore size of the catalyst particles themselves and/or (in the case of a supported catalyst) of the catalyst-coated article or structure; the former dictates the degree to which reactant molecules in the frying oil (FFAs, mono- and diglycerides, etc.) can diffuse into and through the catalyst particles, and the latter dictates the degree to which catalyst molecules can diffuse into and through the structure or substrate. In embodiments, the pore sizes of catalyst particles may range as from as small as about 4 Å (0.4 nm) to as large as about 1,500 μm, or alternatively in any range having a lower bound of any whole number of angstroms from 4 Å to 1,500 μm and an upper bound of any other whole number of angstroms from 4 Å to 1,500 μm. In some substrate configurations (e.g., wire meshes in which the catalyst is present as a coating on the wire substrate material), the pore size of the supporting substrate/structure (e.g., the space between strands of the wire mesh), may range from as small as about 0.25 mm to as large as about 25 mm, or alternatively in any range having a lower bound of any quarter of a whole number of millimeters from 0.25 mm to 25 mm and an upper bound of any other quarter of a whole number of millimeters from 0.25 mm to 25 mm. In some embodiments, e.g., where the catalyst is present as a coating on a plurality of glass beads or other small non-porous (and usually spherical or approximately spherical) objects, diffusion of the reactant molecules in the frying oil may occur through the spaces between each object; in these embodiments, the diameter of each non-porous object may be selected so as to ensure a desired surface area per volume and/or mass of catalyst-coated objects, while still allowing diffusion of the reactant molecules in the frying oil around, and through the spaces between, the objects.

Still another important parameter of catalysts suitable for use in the methods and systems of the present disclosure is the chemical and thermal durability of the catalyst and/or of the structure or substrate on which the catalyst is supported. Particularly, because the catalysts are used in the frying of foods for human consumption, it is generally highly desirable that materials of the catalyst and of any supporting structure or substrate have no or low toxicity, do not decompose into toxic byproducts at frying temperatures, and are insoluble or poorly soluble in the frying oil such that they do not leach into the frying oil in amounts that exceed those generally recognized as safe.

Still another important parameter of catalysts, particularly supported catalysts, suitable for use in the methods and systems of the present disclosure is the stability of the catalyst and/or of the structure or substrate on which the catalyst is supported. Particularly, because the catalysts are used in the frying of foods for human consumption, it is generally highly desirable that materials of the catalyst and of any supporting structure or substrate, under frying conditions and while in contact with a frying oil, (1) are insoluble or poorly soluble in the frying oil, and (2) have sufficient hardness and/or resistance to friability to resist “dusting” or “shedding” due to contact or abrasion by other catalyst substrate material(s). Thus, for example, the frying oil can remain in contact with a “stable” structured catalyst under frying conditions for a prolonged period (in many cases, at least about 30 days) without any significant increase in the concentration of dissolved and/or free particles of the catalyst material(s) and/or the material(s) of the support structure or substrate in the frying oil. By way of further non-limiting example, the content of free particles of the catalyst material(s) and/or the material(s) of the support structure or substrate in the frying oil may remain well below the upper limit considered acceptable in food even after a prolonged period of contact (e.g., at least about 30 days) between the frying oil and the supported catalyst. In some embodiments, the catalyst material(s) and/or the material(s) of the support structure or substrate may be generally recognized as safe (GRAS) by a relevant regulatory authority, e.g., the United

### States Food and Drug Administration.

Yet another important parameter of supported catalysts suitable for use in the methods and systems of the present disclosure is the extent to which the catalyst itself, and the materials making up the support structure or substrate, are “inert” under frying conditions. Particularly, because the catalysts are used in the frying of foods for human consumption, it is generally highly desirable that materials of the catalyst and of any supporting structure or substrate have no or very little tendency to induce, cause, catalyze, or accelerate a frying oil degradation reaction under typical frying conditions. Thus, for example, the frying oil can remain in contact with an “inert” structured catalyst under frying conditions for a prolonged period (in many cases, at least about 30 days) without any significant increase in the rate of any oil degradation reaction relative to maintaining the frying oil under the same frying conditions in the absence of the structured catalyst.

Yet another important parameter of supported catalysts suitable for use in the methods and systems of the present disclosure is the spatial distribution of the catalyst on the supporting structure or substrate. For most applications, the ideal spatial distribution of the catalyst on the supporting structure or substrate is a monoatomic or monomolecular layer disposed substantially uniformly about the entire oil-facing surface, or at least as great a portion of the oil-facing surface as possible, of the supporting structure or substrate, as these generally provide the highest catalytic efficiency relative to other spatial distributions of catalyst. However, in certain embodiments, other catalyst geometries may be desirable, and skilled artisans may design or select such other catalyst geometries without departing from the scope or spirit of the present disclosure.

In the methods and systems of the present disclosure, the catalyst may be coated or deposited on any suitable supporting structure or substrate, in view of the considerations described in the preceding paragraphs. Non-limiting examples of structures or substrates that may suitably be used to support re-esterification catalysts in embodiments of the present disclosure include porous zeolitic beads, alumina supports, zirconia (e.g., yttria-stabilized zirconia) supports, silica supports, titania supports, ceramic supports, glass surfaces, nanoscale porous ceramic fibers, wire meshes, rods (having any suitable diameter, which may in some embodiments be about 0.5 mm to about 2 mm, and any suitable length, which may in some embodiments be about 1 mm to about 3 mm), honeycomb structures, structures having many pores or channels with round or polygonal cross-sections, spheres (having any suitable diameter, which may in some embodiments be about 0.25 mm to about 4 mm), plates, tubes, random geometric structures (e.g., planar shapes having any suitable thickness, which may in some embodiments be about 0.25 mm to about 2 mm, and any suitable volume, which may in some embodiments be about 1 mm² to about 25 mm²), and components (or portions of components) of frying devices, systems, or vessels, so long as the support exhibits sufficient inert behavior and stability (as those terms are defined and described elsewhere throughout this disclosure) under frying conditions. One type of support that the present inventors have identified as being particularly suitable is yttria-stabilized zirconia (YSZ). This type of substrate provides several advantages, including commercial availability, acceptability/safety for direct contact with food, high temperature resistance, scalability of deposition techniques of catalyst, surface modification (e.g. etching techniques) for increased surface area, durability, toughness, inert behavior under frying conditions, and stability. In many embodiments, it may be desirable to provide a support having a higher effective surface area and/or a larger pore size to improve diffusion of reactant molecules in the frying oil through the support. In some embodiments, a desirable balance between effective catalyst surface area on the one hand (to increase re-esterification reaction rate and improve catalyst effectiveness) and stability and inertness of a structured catalyst on the other hand (to ensure the catalyst may be safely and effectively used for an extended period in the frying oil) may be achieved by providing the structured catalyst (i.e., the substrate/support material, the catalyst coating/layer, or both) with an appropriate surface texture, e.g., a nano-scale roughness or micro-scale roughness.

Skilled artisans, in view of the above considerations, can select and optimize an appropriate catalyst and an appropriate material and geometry of the supporting structure or substrate (in the case of supported catalysts). This selection, as skilled artisans will appreciate in view of the present disclosure, is motivated by the reaction kinetics required to keep FFA and TPM levels in the frying oil to acceptable levels. Particularly, because in commercial frying operations the same oil is used continuously or near-continuously over periods of at least about several days, skilled artisans may select a catalyst and catalyst support structure that ensures appropriate absolute and/or relative levels of FFAs, TPMs/TPCs, and mono-, di-, and/or triglycerides in the frying oil not just at the end of the oil's intended life but at all time points during the frying operation as well. Thus, skilled artisans can, in view of the present disclosure, tailor their catalysts and catalyst structures to most cost-effectively reduce the accumulation of undesirable degradation byproducts in the frying oil, favorably interfere with or disrupt the autooxidation reaction cascade, and extend the oil life by multiple times relative to existing techniques, all of which improve the quality and consistency of foods fried in the frying oil.

### Catalytic Sub-System: Structured Catalysts

The present inventors have found that a structured catalyst, comprising a suitable substrate (e.g., alumina or yttria-stabilized zirconia substrates) coated with a thin layer (in some embodiments, a monomolecular or monoatomic layer) of one or more catalyst materials described herein (e.g., zinc oxide), exhibits advantageous stability and inert behavior under frying conditions. The desirable performance attributes of structured catalysts of this type in the high-temperature frying environment are a surprising and unexpected advantage of using these structured catalysts. Thus, embodiments of the methods and systems of the present disclosure utilize structured catalysts of this type.

### Adsorption Sub-System

In methods and systems of the present disclosure, the catalytic sub-system described above, which includes a re-esterification catalyst and, in many embodiments, a supporting structure or substrate for the catalyst, is supplemented by an adsorption sub-system. Like the catalytic sub-system, the adsorption sub-system is an “active” sub-system in that it reduces degradation of a frying oil by altering the chemistry of the frying oil. Particularly, the adsorption sub-systems of the present disclosure take advantage of the fact that TPMs, by virtue of their polarity, have an affinity for adsorption onto hydrophilic substrates; thus, the adsorption sub-system includes a TPM adsorbent material comprising a hydrophilic surface in contact with the frying oil, onto which TPMs in the oil can adsorb and thereby be removed from the oil. Systems according to the present disclosure can thus be “hybrid” systems that reduce degradation of frying oil by both of two separate mechanisms: (1) catalyzing re-esterification of glycerol and mono- and diglycerides in the frying oil into triglycerides via the catalytic sub-system, and (2) reducing the TPM content of the oil via the adsorption sub-system.

One advantage of the adsorption sub-systems of the present disclosure compared to previous techniques for managing the TPM content of frying oils is that the adsorbent is not a disposable or single-use adsorbent, upon which previous adsorption techniques have generally relied. Rather, the adsorbents used in adsorption sub-systems according to the present disclosure are regenerable—that is, once the adsorption surface of the adsorbent becomes saturated with TPMs, the TPMs can readily be removed from the adsorption surface for disposal or downstream processing and the adsorbent can then be returned to service in the frying operation. This feature significantly reduces the quantity of waste generated by the adsorption sub-system relative to conventional processes for managing TPM content.

In some embodiments, the adsorbent material may be contained within a reusable cartridge configured with many holes or openings large enough for the oil to flow through to contact the adsorbent material but small enough to prevent the adsorbent material from escaping the cartridge. Such a cartridge can be placed in the frying oil (e.g., during or after cooling of the frying oil to room temperature or a holding temperature, as described with reference to FIG. 2 above) for sufficient time to allow TPMs to be adsorbed from the oil to a desired extent, after which the cartridge may be removed from the frying oil and the adsorbent material may be regenerated by any one or more regeneration techniques, including but not limited to washing with hot (e.g., at least about 150° F.) water, steam cleaning, or cleaning with a non-aqueous solvent. In some embodiments, regeneration of the adsorbent material can be accomplished by washing the adsorbent cartridge in a home or commercial- or industrial-grade dishwasher.

Another advantage of the adsorption sub-systems of the present disclosure compared to previous techniques for managing the TPM content of frying oils is that, like the catalytic sub-systems disclosed herein, they are effective for in situ treatment of the frying oil, i.e., the frying oil does not need to be removed from the location where the frying operation is carried out. As a result, the adsorption sub-system can easily be incorporated into pre-existing frying operations, with little or no deviation from already-established activities and schedules. This characteristic of the adsorption sub-system improves operator compliance and operational safety and results in significant labor savings relative to conventional processes for managing TPM content.

While adsorption sub-systems according to the present disclosure are suitable for use in conjunction with fresh frying oils to prevent accumulation of TPMs in the first place, it is to be expressly understood that in many embodiments they may also be utilized to remediate and/or recover used frying oils that already include significant quantities of TPMs. Particularly, the rate at which adsorbents included in adsorption sub-systems according to the present disclosure remove TPMs from the frying oil may be higher than the rate at which TPMs are formed in the frying oil, such that the overall TPM content of the frying oil is reduced over time. In some embodiments, the adsorption sub-system may be effective to remove at least about 50% of TPMs from a used frying oil.

As with the catalyst of the catalytic sub-system and any supporting substrate or structure therefor, two important considerations in selecting an adsorbent for the adsorption sub-system are the stability of the adsorbent under frying conditions and the extent to which the adsorbent is inert with the frying oil at frying conditions. Non-limiting examples of adsorbent materials that are sufficiently stable and inert under frying conditions while maintaining good TPM adsorption capabilities at or near frying temperatures include stainless steel, iron granules, copper powder, and beads or meshes of silica gel (either unfunctionalized or functionalized, e.g., with aminopropyl or octadecyl functionality). In some embodiments, silica gel beads suitable as adsorbent materials may have a particle/bead size from about 0.25 mm to about 4 mm, or any value in any subrange thereof.

In general, whereas the re-esterification catalyst of the catalytic subsystem and the frying oil may remain in contact for many days on end to allow the catalyst to continuously promote re-esterification in the frying oil, the adsorbent of the adsorption subsystem may in many embodiments remain in contact with the frying oil for only a few hours at a time, as this time is sufficient to allow for adsorption of a substantial fraction of TPMs that have built up in the frying oil over the course of a frying operation. In embodiments, the adsorbent and the frying oil may remain in contact for at least about two hours, at least about three hours, at least about four hours, at least about five hours, at least about six hours, at least about seven hours, at least about eight hours, at least about nine hours, at least about ten hours, or at least about eleven hours, and/or no more than about twelve hours, no more than about eleven hours, no more than about ten hours, no more than about nine hours, no more than about eight hours, no more than about seven hours, no more than about six hours, no more than about five hours, no more than about four hours, or no more than about three hours, and/or any length of time in any range having a lower bound of any whole number of minutes between 120 minutes and 720 minutes and an upper bound of any other whole number of minutes between 120 minutes and 720 minutes. As further disclosed elsewhere, following this period of contact with the frying oil, the adsorbent material may be removed from the frying oil and regenerated.

### Complementary and Supplementary Mitigation of Thermal Oxidation Byproducts

A complicating issue in the development of complete frying oil life extension and treatment systems is the production of polar organic molecules due to rapid thermally driven oxidation of the base oil and/or incomplete re-esterification. Polar organics are undesirable in frying oils, and in many operations the concentration of polar organics in the oil (usually expressed as “total polar molecules,” or TPMs) is a metric for determining when the oil must be replaced. To further address this complicating issue, methods and systems of the present disclosure may provide oil life extension and oil treatment features in addition to re-esterification of glycerol, FFAs, and mono- and diglycerides.

One such additional feature that may suitably be included or employed in some embodiments is the use of ion exchange and/or ion adsorption media. In ion adsorption, ions are transferred from a liquid phase onto the surface of a solid phase, often due to an electrical attraction of the ions to a substance on the surface of the solid phase; in other words, the solid phase gains ions, but does not lose them. In ion exchange, an ion in the liquid phase, upon encountering the solid medium, displaces an ion from the solid material; in other words, the solid phase both gains and loses ions. In most frying oils, which consist of a complex blend of chemical components, a combination of both ion exchange and ion adsorption would be most desirable; an ideal medium would therefore have one or both of an electrical charge and ions that can be transferred to the oil, both of which would cause polar organics to be adsorbed onto the solid medium. This substrate could then be disposed of or regenerated (by chemical and/or physical means) and reused.

Other complementary and/or supplementary techniques for removing polar organics from the frying oil or preventing their formation include, by way of non-limiting example, (non-ionic) adsorption, addition of hydrogen to (or production of hydrogen within) the frying oil, and addition of antioxidants to the frying oil. These and other complementary and/or supplementary techniques may be combined with the re-esterification techniques disclosed herein within the scope of embodiments of the present disclosure.

Embodiments of the present disclosure are further described by way of the following non-limiting Examples.

### Example 1

### FFA Content of Frying Oils Re-Esterified by Bulk/Free Particle Catalyst

Several tests were carried out in which a plant-based frying oil—either a used frying oil initially containing 8.49 wt % FFAs, or a blend consisting of 25 wt % of this used frying oil and 75 wt % of a fresh frying oil initially containing 0.26 wt % FFAs (the blend thus initially containing 2.32 wt % FFAs)—was heated to a temperature typical of frying operations for several hours in the presence of bulk/free particles of a re-esterification catalyst (zinc chloride or zinc oxide) as disclosed herein. In some test runs, glycerol was added to the frying oil at the outset of the test to provide a 1:1 molar ratio of glycerol to FFAs, while in other test runs the glycerol/FFA ratio was uncontrolled (i.e., no glycerol was added to the frying oil). The re-esterification catalyst was provided unsupported in the form of bulk particles. At the end of each test, the FFA content of the frying oil was measured to assess the FFA mitigation performance of each catalyst under varying test conditions.

The results of these tests are given in Table 1.

TABLE 1

| | | | | | | | Final |
|---|---|---|---|---|---|---|---|
| | | | Catalyst | | | Glycerol/ | FFA |
| Test | Oil | | conc. | Temp. | Time | FFA initial | conc. |
| ID | type | Catalyst | (wt %) | (° C.) | (h) | ratio | (wt %) |
| 1 | Blend | ZnCl₂ | 0.30 | 170 | 3 | Controlled | 1.39 |
| | | | | | | (1:1) | |
| 2 | Used | ZnCl₂ | 0.30 | 195 | 6 | Controlled | 2.25 |
| | | | | | | (1:1) | |
| 3 | Used | ZnCl₂ | 0.30 | 170 | 9 | Controlled | 1.76 |
| | | | | | | (1:1) | |
| 4 | Used | ZnCl₂ | 0.30 | 180 | 12 | Controlled | 1.68 |
| | | | | | | (1:1) | |
| 5 | Used | ZnCl₂ | 0.30 | 170 | 24 | Controlled | 1.83 |
| | | | | | | (1:1) | |
| 6 | Used | ZnCl₂ | 0.10 | 170 | 6 | Controlled | 2.11 |
| | | | | | | (1:1) | |
| 7 | Used | ZnO | 0.50 | 170 | 6 | Controlled | 3.20 |
| | | | | | | (1:1) | |
| 8 | Used | ZnO | 0.50 | 170 | 24 | Controlled | 1.37 |
| | | | | | | (1:1) | |
| 9 | Used | ZnO | 0.50 | 170 | 6 | Uncontrolled | 3.74 |
| 10 | Used | ZnO | 0.50 | 170 | 24 | Uncontrolled | 2.23 |

As test IDs 9 and 10 demonstrate, even when the initial molar ratio of glycerol is uncontrolled, the use of bulk/free particles of a re-esterification catalyst in a frying operation can reduce the quantity of FFAs in a used frying oil by more than 50% (8.49 wt % to 3.74 wt %) over 6 hours of frying time and by more than 75% (8.49 wt % to 2.23 wt %) over 24 hours of frying time.

### Example 2

### Fatty Acid and Fatty Ester Profile of Re-Esterified Frying Oils

The concentrations of various fatty acids and fatty acid esters in the oils resulting from tests 7-10 in Example 1 were measured at the end of each test to assess the effect of frying time and initial glycerol/FFA ratio on the fatty acid profiles in the oils. The results of these measurements are given in Table 2; the units on all results are weight percent (wt %) of the total weight of the oil.

TABLE 2

| | Test #7 | Test #8 | Test #9 | Test #10 |
|---|---|---|---|---|
| Total fat | 100.00 | 100.00 | 100.00 | 100.00 |
| Saturated fat | 14.55 | 14.34 | 14.45 | 14.41 |
| Monounsaturated fat | 59.18 | 59.47 | 59.45 | 59.44 |
| Polyunsaturated fat | 26.27 | 26.19 | 26.10 | 26.15 |
| ω-3 fat | 2.86 | 2.94 | 2.79 | 2.79 |
| ω-6 fat | 22.83 | 22.70 | 22.75 | 22.75 |
| ω-9 fat | 58.72 | 59.04 | 59.01 | 58.98 |
| Trans fat | 0.23 | 0.19 | 0.10 | 0.11 |
| Monoglycerides | 22.58 | 27.52 | 13.04 | 13.41 |
| Diglycerides | 22.83 | 20.68 | 17.09 | 12.25 |
| Triglycerides | 44.51 | 39.22 | 57.97 | 67.46 |

As a comparison between test IDs 7 and 8 on the one hand and test IDs 9 and 10 on the other hand demonstrates, the use of bulk/free particles of a re-esterification catalyst without addition of glycerol in a frying operation can reduce the quantity of mono- and diglycerides in a used frying oil by at least as much as 46% and increase the quantity of triglycerides by at least as much as 72% compared to the same catalyst in the presence of additional exogenous glycerol.

### Example 3

### Stability Performance of Various Catalysts and Catalyst Support Materials

A number of catalyst support materials without catalyst, unsupported catalysts, and structured catalysts were exposed to a plant-based frying oil at a temperature of 170° C. for periods of at least about 24 hours. At the end of the exposure period, the frying oil was assayed to determine the extent to which the support material and/or the catalyst had “dusted” or “shed” into the frying oil. Results are given in Table 3.

TABLE 3

| | | | Support | Catalyst |
|---|---|---|---|---|
| | | Ex- | mat'l | in oil |
| | | posure | in oil at | at test |
| Support | Catalyst | time | test end | end |
| material | material | (hr) | (ppm) | (ppm) |
| α-Alumina | None | 24 | 8.8 | n/a |
| γ-Alumina | | | 522.44 | |
| Titanium(IV) oxide | | | 10.38 | |
| Zirconium oxide | | | 67.5 | |
| Zeolite Z4A1.3 | | | 376.32 | |
| Zeolite Z4A1.5 | | | 136.79 | |
| Alumina “C” | | 24 | <1.0 | |
| | | 120 | 1.22 | |
| | | 216 | 1.08 | |
| Yttria-stabilized zirconia | | 24 | <1.0 | |
| | | 120 | | |
| | | 216 | | |
| None | ZnO | 24 | n/a | 324.4 |
| (unsupported particles) | | 120 | | 181.63 |
| | | 216 | | 4542.96 |
| Alumino-silicate | | 24 | <1.0 | 466.23 |
| Alumina “C” | | 24 | 1.30 | 69.26 |
| | | 120 | 0.98 | 51.05 |
| | | 216 | 14.05 | 1110.00 |
| Yttria-stabilized zirconia | | 24 | <1.0 | 17.42 |
| | | 120 | | 10.69 |
| | | 216 | | 7.83 |
| | | 312 | | 8.67 |
| | | 408 | | 4.18 |

### Example 4

### Performance of Re-Esterification Catalysts Over 96 Hours at Frying Conditions

Each of several 50 g structured zinc oxide (ZnO) catalysts was placed in contact with 200 g of a blended plant-based frying oil, consisting of 65 wt % “fresh” oil and 35 wt % “used” oil, and held at a temperature of 170° C. for 96 hours. At the end of the test period, the frying oil was assayed to determine the TPM content of the frying oil; a control run, with no catalyst present, was also tested in this manner. Results are given in Table 4.

TABLE 4

| | | TPMs | TPM reduction |
|---|---|---|---|
| Sample | | in oil | relative to |
| ID | Support material | (wt %) | control |
| Control | n/a | 20.68 | n/a |
| 1 | Alumina milling media balls | 13.88 | 32.88% |
| 2 | | 15.09 | 27.03% |
| 3 | Yttria-stabilized zirconia | 18.71 | 9.53% |
| 4 | | 17.74 | 14.22% |

### Example 5

### Stability of Various TPM Adsorbent Materials

Beads of silica hydrogel “C” were placed in baths of a plant-based frying oil at 170° C. for periods of 30 minutes to 24 hours. The silica content of the gel was determined both prior to contact with the hydrogel beads and after the test period to determine the stability of the silica hydrogel beads. Results are given in Table 5 (note that two different 24-hour test runs were performed).

TABLE 5

| Exposure | Silica content in oil (ppm) | | Change in silica |
|---|---|---|---|
| time (hr) | Start | End | content (ppm) |
| 0.5 | 1.64 | 2.85 | 1.21 |
| 1.0 | 2.11 | 4.21 | 2.10 |
| 2.0 | 2.19 | 4.65 | 2.46 |
| 24 | 1.54 | 5.11 | 3.57 |
| 24 | 1.48 | 4.05 | 2.57 |

### Example 6

### TPM Adsorption Performance of Various TPM Adsorbent Materials

Four separate batches of the 65/35 frying oil blend described in Example 4 were maintained at a frying temperature of 170° C. for 20 hours. After this 20-hour heating period, silica hydrogel adsorbent beads were placed in three of the four batches of oil while the oil cooled to room temperature (the fourth batch was not contacted with an adsorbent and was used as a control). Upon reaching room temperature, the beads were removed and the TPM content of each batch of oil was assayed to determine the reduction in TPMs achieved by the silica hydrogel adsorbent.

TABLE 6

| Run | Adsorbent mass | Oil mass | TPMs | TPM reduction |
|---|---|---|---|---|
| ID | (g) | (g) | (wt %) | relative to control |
| Control | 0 | 199.0 | 39.72 | n/a |
| 1 | 50.12 | 199.3 | 15.53 | 60.90% |
| 2 | 50.13 | 199.8 | 18.06 | 54.53% |
| 3 | 50.59 | 201.2 | 19.80 | 50.15% |

### Example 7

### FFA Content of Frying Oils Re-Esterified by Structured Catalyst

Six batches of a 65/35 frying oil blend as described in Example 4 were heated to a temperature typical of frying operations and maintained at this temperature for at least 24 hours. Each of these six batches of oil was in continuous contact with a structured zinc oxide (ZnO) catalyst as disclosed herein. Separately, two batches of the same oil were held at room temperature in the absence of any re-esterification catalyst as controls. At the end of each test, the FFA content of the frying oil was measured to assess the FFA mitigation performance of each catalyst under varying test conditions.

The results of these tests are given in Tables 7 and 8. Note that the oil of test IDs 1-4 had the same starting composition as Control 1, and the oil of test IDs 5 and 6 had the same starting composition as Control 2.

TABLE 7

| | | | Structured | Initial | | |
|---|---|---|---|---|---|---|
| | | | catalyst | oil mass | Temp. | Time |
| Test ID | Catalyst | Support | mass (g) | (g) | (° C.) | (hr) |
| Control 1 | None | None | n/a | 160.0 | Room | n/a |
| Control 2 | | | | 200.0 | | |
| 1 | ZnO | YSZ | 25.06 | 160.0 | 170 | 24 |
| 2 | | | 54.13 | 160.0 | | |
| 3 | | Alumina milling | 85.41 | 202.6 | | |
| 4 | | media balls | 59.95 | 200.0 | | |
| 5 | ZnO | YSZ | 50.10 | 200.7 | 170 | 96 |
| 6 | | | 49.30 | 200.3 | | |

TABLE 8

| | FFA content | Reduction in FFAs |
|---|---|---|
| Test ID | (wt %) | relative to control |
| Control 1 | 1.70 | n/a |
| Control 2 | 2.47 | |
| 1 | 0.41 | 75.88% |
| 2 | 0.32 | 81.18% |
| 3 | 0.70 | 58.82% |
| 4 | 0.80 | 52.94% |
| 5 | 1.02 | 58.70% |
| 6 | 0.78 | 68.42% |

The data of this Example indicate that re-esterification catalysts, and in particular structured re-esterification catalysts, according to the present disclosure can not only remediate the high FFA contents of used cooking oils (as shown in Examples 1 and 2), but can greatly reduce the FFA content in “fresher” oils with significantly lower starting FFA contents as well. The re-esterification systems and methods of the present disclosure are thus effective to extend the usable life of cooking oils at all stages of their lifecycle.

The concepts illustratively disclosed herein suitably may be practiced in the absence of any element which is not specifically disclosed herein. It is apparent to those skilled in the art, however, that many changes, variations, modifications, other uses, and applications of the disclosure are possible, and changes, variations, modifications, other uses, and applications which do not depart from the spirit and scope of the disclosure are deemed to be covered by the disclosure.

The foregoing discussion has been presented for purposes of illustration and description. The foregoing is not intended to limit the disclosure to the form or forms disclosed herein. In the foregoing Detailed Description, for example, various features are grouped together in one or more embodiments for the purpose of streamlining the disclosure. The features of the embodiments may be combined in alternate embodiments other than those discussed above. This method of disclosure is not to be interpreted as reflecting an intention that the claims require more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate embodiment.

Moreover, though the present disclosure has included description of one or more embodiments and certain variations and modifications, other variations, combinations, and modifications are within the scope of the disclosure, e.g. as may be within the skill and knowledge of those in the art, after understanding the present disclosure. It is intended to obtain rights which include alternative embodiments to the extent permitted, including alternate, interchangeable, and/or equivalent structures, functions, ranges, or steps to those claimed, regardless of whether such alternate, interchangeable, and/or equivalent structures, functions, ranges, or steps are disclosed herein, and without intending to publicly dedicate any patentable subject matter.

1. A method for reducing degradation of a frying oil, comprising:
(a) contacting the frying oil with a catalyst selected from the group consisting of zinc metal, chloride salts of zinc or tin, oxide salts of zinc or tin, sulfate salts of zinc or tin, and combinations thereof; and
(b) maintaining the frying oil at a temperature from about 120° C. to about 200° C. during step (a).

2. The method of claim 1, further comprising:
(c) contacting the frying oil with an adsorbent selected from the group consisting of a functionalized silica gel, an unfunctionalized silica gel, and combinations thereof.

3. The method of claim 2, wherein the adsorbent comprises a silica gel functionalized with aminopropyl groups, octadecyl groups, or combinations thereof.

4. The method of claim 2 or claim 3, wherein the silica gel is in the form of beads having an average bead size from about 0.25 mm to about 4 mm.

5. The method of any one of claims 2-4, wherein the frying oil and the adsorbent remain in contact continuously for a period of about two hours to about twelve hours.

6. The method of any one of claims 2-5, wherein step (c) is carried out for a predetermined period, and wherein, at the end of the predetermined period, the frying oil comprises no more than about 25 wt % polar compounds.

7. The method of claim 6, wherein the frying oil comprises no more than about 25 wt % polar compounds at all times during the predetermined period.

8. The method of any one of claims 2-7, wherein, during at least part of the duration of step (c), food is not fried in the frying oil contained in the frying vessel.

9. The method of any one of claims 2-8, wherein one of the following is true:
(i) step (a) begins before step (c) begins;
(ii) step (a) begins at the same time that step (c) begins; or
(iii) step (a) begins after step (c) begins.

10. The method of any one of claims 2-9, wherein one of the following is true:
(iv) step (a) ends before step (c) ends;
(v) step (a) ends at the same time that step (c) ends; or
(vi) step (a) ends after step (c) ends.

11. The method of any one of claims 1-10, wherein no exogenous reactant is added to a vessel in which step (a) is carried out.

12. The method of any one of claims 1-11, wherein the frying oil and the catalyst remain in contact continuously for a period of at least about three hours, at least about six hours, at least about nine hours, at least about twelve hours, at least about eighteen hours, at least about one day, at least about two days, at least about three days, at least about four days, at least about five days, at least about six days, or at least about seven days.

13. The method of any one of claims 1-12, wherein step (a) is carried out for a predetermined period, and wherein, at the end of the predetermined period, at least one of the following is true:
(i) the frying oil comprises no more than about 3 wt % free fatty acids;
(ii) the frying oil comprises no more than about 18 wt % monoglycerides;
(iii) the frying oil comprises no more than about 15 wt % diglycerides; and
(iv) the frying oil comprises at least about 60 wt % triglycerides.

14. The method of claim 13, wherein at least one of (i), (ii), (iii), and (iv) is true at all times during the predetermined period.

15. The method of any one of claims 1-14, wherein step (a) prevents, or decreases the rate of, an autooxidation reaction.

16. The method of any one of claims 1-15, wherein step (a) is carried out in a frying vessel, wherein food is fried in the frying oil contained in the frying vessel during at least part of a duration of step (a).

17. The method of claim 16, wherein, during at least part of the duration of step (a), food is not fried in the frying oil contained in the frying vessel.

18. The method of any one of claims 1-17, wherein the temperature is from about 150° C. to about 190° C.

19. The method of claim 18, wherein the temperature is about 170° C.

20. The method of any one of claims 1-19, wherein steps (a) and (b) are carried out at an ambient pressure of no more than about 1 atm.

21. The method of claim 20, wherein the ambient pressure is from about 90 kPa to about 1 atm.

22. The method of any one of claims 1-21, wherein the catalyst is selected from the group consisting of zinc metal, zinc chloride (ZnCl₂), zinc oxide (ZnO), zinc sulfate heptahydrate (ZnSO₄·7H₂O), tin(II) chloride dihydrate (SnCl₂·2H₂O), tin(IV) chloride pentahydrate (SnCl₄·5H₂O), and combinations thereof.

23. The method of any one of claims 1-22, wherein, at an outset of step (a), a molar ratio of glycerol to free fatty acids in the frying oil is between about 0.5 and about 2.0.

24. The method of claim 23, wherein, at the outset of step (a), the molar ratio of glycerol to free fatty acids in the frying oil is about 1.0.

25. The method of any one of claims 1-24, wherein the catalyst is present in an amount from about 0.05 wt % to about 1.5 wt % of a total weight of the frying oil.

26. The method of any one of claims 1-25, wherein the catalyst is insoluble or poorly soluble in the frying oil.

27. The method of any one of claims 1-26, wherein at least part of the catalyst is provided on a surface of at least one supporting structure or substrate.

28. The method of claim 27, wherein the at least one supporting structure or substrate comprises at least one of a porous zeolitic bead, an alumina support, a zirconia support, a silica support, a titania support, a ceramic support, a glass surface, a nanoscale porous ceramic fiber, a wire mesh, a rod, a honeycomb structure, a structure having many pores or channels with round or polygonal cross-sections, a sphere, a plate, a tube, and a random geometric structure.

29. The method of claim 28, wherein the at least one supporting structure or substrate comprises yttria-stabilized zirconia.

30. A system for reducing degradation of a frying oil, comprising:
a frying vessel; and
disposed within the frying vessel, a plurality of particles of a catalyst selected from the group consisting of zinc metal, chloride salts of zinc or tin, oxide salts of zinc or tin, sulfate salts of zinc or tin, and combinations thereof,
wherein the frying vessel is configured to receive the frying oil and heat the frying oil to a temperature from about 120° C. to about 200° C.

31. The system of claim 30, further comprising an adsorbent selected from the group consisting of a functionalized silica gel, an unfunctionalized silica gel, and combinations thereof, wherein at least one of the following is true:
(i) the adsorbent is disposed within the frying vessel; and
(ii) the system further comprises a holding vessel and at least a portion of the adsorbent is disposed within the holding vessel.

32. The system of claim 31, wherein the adsorbent comprises a silica gel functionalized with aminopropyl groups, octadecyl groups, or combinations thereof.

33. The system of claim 31 or claim 32, wherein the silica gel is in the form of beads having an average bead size from about 0.25 mm to about 4 mm.

34. The system of any one of claims 30-33, wherein at least a portion of the particles are provided as a coating on at least one supporting structure or substrate.

35. The system of claim 34, wherein the at least one supporting structure or substrate comprises at least one of a porous zeolitic bead, an alumina support, a zirconia support, a silica support, a titania support, a ceramic support, a glass surface, a nanoscale porous ceramic fiber, a wire mesh, a rod, a honeycomb structure, a structure having many pores or channels with round or polygonal cross-sections, a sphere, a plate, a tube, and a random geometric structure.

36. The system of claim 34 or claim 35, wherein an average pore size of the at least one supporting structure or substrate is from about 0.25 mm to about 25 mm.

37. The system of any one of claims 34-36, wherein the at least one supporting structure or substrate comprises yttria-stabilized zirconia.

38. The system of any one of claims 34-37, wherein at least a portion of the coating is a monoatomic or monomolecular layer.

39. The system of any one of claims 30-38, wherein an average pore size of the catalyst particles is from about 0.4 nm to about 1,500 μm.

40. The system of any one of claims 30-39, wherein the catalyst is insoluble or poorly soluble in the frying oil.

41. The system of any one of claims 30-40, wherein the frying vessel is further configured to promote the catalyst by imparting energy other than heat to the catalyst.

42. The system of claim 41, wherein the imparting step is selected from the group consisting of agitating the catalyst, exposing the catalyst to ultraviolet light, and combinations thereof.
